(19) United States
(12) Patent Application Publication
(10) Pub. No.: US 2025/0322630 A1
(43) Pub. Date: Oct. 16, 2025

(54) Rule-Based Method for 3D Mesh Deformation

(71) Applicant: Telefonaktiebolaget LM Ericsson (publ), Stockholm (SE)

(72) Inventors: Erlendur Karlsson, Uppsala (SE); Mengqiu Zhang, Stockholm (SE); Ioannis Athanasiadis, Linköping (SE)

(21) Appl. No.: 18/871,841

(22) PCT Filed: Jun. 13, 2023
(86) PCT No.: PCT/EP2023/065831

§ 371 Date: Dec. 5, 2024

(30) Foreign Application Priority Data
Jun. 17, 2022 (GR) 20220100501

(51) Int. Cl. G06T 19/20; G06T 17/20

(52) U.S. Cl. CPC G06T 19/20; G06T 17/20; G06T 2219/2016

(57) ABSTRACT

Computing equipment is configured to deform a three-dimensional, 3D, polygonal mesh. The computing equipment extracts, from the 3D polygonal mesh, landmark(s) that form physical feature(s) specified by a landmark extraction specification, e.g., in terms of semantic label(s) of the physical feature(s). Equipped also with a mesh editing specification, the computing equipment determines which extracted landmark(s) form target physical feature(s) that the mesh editing specification indicates are to be deformed. The computing equipment deforms the target physical feature(s) in a way specified by the mesh editing specification by manipulating the determined landmark(s) as handle(s). The computing equipment then edits other part(s) of the 3D polygonal mesh as specified by the mesh editing specification, to account for deformation of the target physical feature(s).

### TECHNICAL FIELD

Embodiments presented herein relate to methods and apparatus for deforming a three-dimensional (3D) polygonal mesh.

### BACKGROUND

A person's two ears capture sound waves propagating towards them. A sound wave propagating towards such a listener can be described as arriving from a direction of arrival (DOA) specified by a pair of elevation and azimuth angles in the spherical coordinate system. On the propagation path towards the listener, each sound wave interacts with the listener's outer ears, head, upper torso, and the surrounding matter before reaching the left and right ear drums. This interaction results in temporal and spectral changes of the waveforms reaching the left and right eardrums, some of which are DOA dependent. The auditory system learns to interpret these changes to infer various spatial characteristics of the sound wave itself as well as the acoustic environment in which the listener finds himself or herself. This capability is called spatial hearing, which concerns how the listener evaluates spatial cues embedded in the binaural signal, i.e., the sound signals in the right and the left ear canals, to infer the location of an auditory event elicited by a sound event (a physical sound source) and acoustic characteristics caused by the physical environment (e.g., small room, tiled bathroom, auditorium, cave) the listener is in.

### SUMMARY

The main spatial cues include angular-related cues and distance-related cues. Angular-related cues include binaural cues (i.e., the interaural level difference (ILD) and the interaural time difference (ITD)) and monaural (or spectral) cues. Distance-related cues include intensity and direct-to-reverberant (D/R) energy ratio. FIG. 1 illustrates an example of ITD and spectral cues of a sound wave propagating towards a listener. The two plots illustrate the magnitude responses of a pair of head-related (HR) filters obtained at an elevation of 0 degrees and an azimuth of 40 degrees. The data is from the CIPIC (Center for Imaging Processing and Integrated Computing) HRTF database. See Algazi et al., “The CIPIC HRTF Database,” in IEEE Workshop on Applications of Signal Processing to Audio and Acoustics, Mohonk Mountain House, New Paltz, NY, 2001: subject-ID 28. A mathematical representation of the short time DOA dependent temporal and spectral changes (1-5 msec) of the waveform are the so-called head-related (HR) filters. The frequency domain (FD) representations of those filters are the so-called head-related transfer functions (HRTFs) and the time domain (TD) representations are the head-related impulse responses (HRIRs).

Spatial hearing can be exploited to create a spatial audio scene by reintroducing the spatial cues in the binaural signal that would lead to a spatial perception of a sound. In an HR filter based binaural rendering approach, a spatial audio scene is generated by directly filtering audio source signals with a pair of HR filters of desired locations. This approach is particularly attractive for many emerging applications, e.g., virtual reality (VR), augmented reality (AR), mixed reality (MR), or extended reality (XR), and mobile communication systems, where headsets are commonly used.

Spatial cues embedded in the HR filters are greatly influenced by the interaction of sound waves with a listener's outer ears, head, and upper torso. FIG. 2 (see Algazi et al., “The CIPIC HRTF Database,” in IEEE Workshop on Applications of Signal Processing to Audio and Acoustics, Mohonk Mountain House, New Paltz, NY, 2001) shows an example of some anthropometric measurements of an ear, where d1 is cavum concha height, d2 is cymba concha height, d3 is cavum concha width, d4 is fossa height, d5 is pinna height, d6 is pinna width, d7 is intertragal incisure width, d8 is cavum concha depth, θ1 is pinna rotation angle, and θ2 is pinna flare angle. Anthropometric differences in outer ears, head, and upper torso result in variations in the spatial cues among individuals. Therefore, each individual experiences sound in the real-world slightly differently. Rendering a spatial audio scene that matches with one's real-world audio experience requires personal HR filters.

Personal HR filters can be obtained directly by acoustic measurements on an individual, where the filters are often estimated as the impulse response of a linear invariant system that transforms the original sound signal (input signal) into the left and right ear signals (output signals) that can be measured inside the ear channels of a listening subject at a predefined set of elevation and azimuth angles on a spherical surface of constant radius from the individual under test. The measurement is usually performed in a dedicated audio lab, e.g., an anechoic chamber, which is very expensive to build. Moreover, it is a greatly time-consuming and complicated procedure. Due to the cost and the time-consuming and complicated procedure of the acoustic measurement approach, it is impractical for a large-scale deployment or for consumer-level applications. However, the acoustic measurement remains the reference method to obtain personal HR filters.

Another approach to obtain a personal HR filter set is through numerical simulation of HR filters using Boundary Element Method (BEM), See Kreuzer et al., “Fast multipole boundary element method to calculate head-related transfer functions for a wide frequency range,” The Journal of the Acoustical Society of America, vol. 126, no. 3, pp. 1280-1290, 2009. Given a 3D mesh of ear, head, and/or upper torso of a person, this method evaluates an HR filter set by simulating the sound-field scattered by a human's outer ears, head, and torso. The BEM simulation method requires a fine-grained mesh of the outer ears in order to calculate HR filters for the full audible frequency range. Natural advantages of the numerical simulation approach include that it is insensible to measurement noise and it allows experiments out of reach in real life. However, to obtain such fine grained meshes, advanced 3D capture devices and procedures are required, and safety measures need to be taken to protect subjects from radiation. See Ziegelwanger et al., “Calculation of listener-specific head-related transfer functions: Effect of mesh quality,” in Proceedings of Meetings on Acoustics, Montreal, Canada, 2013. Therefore, the numerical simulation approach is heretofore not practical for obtaining personal HR filters in a large scale.

Yet another approach to obtain a personal HR filter set, then, would be to create a large number of 3D meshes by deforming or editing an existing small number of base 3D meshes acquired by 3D capture devices. Creating a large number of personal HR filters in this way proves more cost-effective for personalizing HR filters for a large number of listeners. Two approaches that use 3D mesh deformation for generating HR filters are represented by the CHEDAR and WiDESPREaD databases.

The CHEDAR database, which can be accessed from the link http://sofacoustics.org/data/database/chedar/, contains 1253 sets of computed HR filters and their associated 3D meshes. All meshes were derived from one 3D model of ear, head, and torso, where the deformations are controlled by a set of blendshapes. This blendshape-approach allows to achieve numerous pre-defined shapes and any number of combinations of in-between the base and the pre-defined shapes. But, apparently, there is no control over how much deformation is done in the in-between meshes. Originally, 1296 meshes were generated while 43 of them presented self-intersections, which are not suitable for HR filter simulation and were discarded. Another drawback of using blendshapes is that every vertex position must be manually manipulated, which is labor-intensive and makes it difficult to control that the deformed meshes are representative of human outer ear meshes.

The WiDESPREaD database, which can be accessed from the link https://www.sofacoustics.org/data/database/widespread, contains deformed ear meshes and corresponding computed pinna-related transfer function (PRTF) sets based on a proprietary dataset of 119 3D left-ear scans. In this database, the ear meshes were generated from an ear shape model using principal component analysis (PCA), where the model weights were obtained independently according to norm distribution with zero mean and certain standard deviations. This PCA-model-approach, however, results in meshes with self-intersecting faces. The verification result shows that as high as 24% (320 out of 1325) of the deformed meshes presented at least one self-intersecting face and they were discarded.

Existing approaches to generating a large number of personal HR filters therefore prove inadequate in a number of respects. Worse, existing approaches to efficient 3D mesh deformation in other technical areas, such as geometric modeling, computer animation, and computer graphics, are inadequate for personal HR filter generation. Examples of such existing approaches include cage-based methods, the Laplacian Surface Editing method, a template-based method, a simplification-based method, a bounding shape-based method, a skeleton-based method, and so on. These existing deformation approaches lack the fine-controlled precision required for deforming 3D meshes of small, complex areas, such as the ear, head, and/or upper torso relevant for generating personal HR filters. Furthermore, existing approaches to 3D mesh deformation prove inefficient and impractical for generating a large number of 3D mesh deformations, as significant user involvement is required in order to guide the desired deformation.

Some embodiments herein parameterize three-dimensional (3D) polygonal mesh deformation in a way that enables the deformation to be performed according to specification, e.g., of one or more parameters. For example, some embodiments herein perform 3D polygonal mesh deformation according to specification of which physical feature(s) represented in the 3D polygonal mesh are to be deformed and how those physical feature(s) are to be deformed. Such specification may for instance just generally specify semantic label(s) of the physical feature(s) to be deformed and measure(s) by which the physical feature(s) are to be moved, scaled, and/or rotated. With the physical feature(s) targeted for deformation specified in this way, some embodiments decipher which landmark(s) (e.g., vertice(s)) in the 3D polygonal mesh form those target physical feature(s) and then manipulate the identified landmark(s) as handles in order to deform the target physical feature(s) according to specification.

By providing 3D polygonal mesh deformation according to specification, some embodiments herein are able to generate a large number of 3D polygonal meshes by deforming a small number of 3D polygonal meshes according to different specifications. Some embodiments are able to do so even for 3D meshes of small, complex areas, such as the ear, head, and/or upper torso. Correspondingly, then, some embodiments herein are applicable for generating a large number of head-related (HR) filters that are personalized for a corresponding large number of listeners, e.g., as represented by different deformations of a small number of 3D polygonal meshes of the ear, head, and/or upper torso.

More particularly, embodiments herein include a method performed by computing equipment for deforming a three-dimensional, 3D, polygonal mesh. The method comprises extracting, from the 3D polygonal mesh, one or more landmarks that form one or more physical features specified by a landmark extraction specification. In some embodiments, the landmark extraction specification specifies the one or more physical features by including one or more semantic labels of the one or more physical features. In some embodiments, the one or more semantic labels are associated with one or more parameters according to which the one or more landmarks are to be extracted. The method also comprises determining which one or more extracted landmarks form one or more target physical features that a mesh editing specification indicates are to be deformed. The method also comprises deforming the one or more target physical features in a way specified by the mesh editing specification by manipulating the one or more determined landmarks as one or more handles. The method also comprises editing one or more other parts of the 3D polygonal mesh as specified by the mesh editing specification, to account for deformation of the one or more target physical features.

In some embodiments, the landmark extraction specification specifies the one or more parameters according to which the one or more landmarks are to be extracted.

In some embodiments, the one or more parameters according to which the one or more landmarks are to be extracted include, for each of the one or more physical features, at least a view of the 3D polygonal mesh from which a two-dimensional, 2D, outline of the 3D polygonal mesh is to be extracted. Alternatively, the one or more parameters according to which the one or more landmarks are to be extracted include, for each of the one or more physical features, at least a resolution of points that are to form the 2D outline. Alternatively, the one or more parameters according to which the one or more landmarks are to be extracted include, for each of the one or more physical features, at least a range of points on the 2D outline within which to search for one or more landmarks that form the physical feature.

In some embodiments, extracting the one or more landmarks comprises, for each of one or more views specified by the landmark extraction specification, extracting a 2D outline of the 3D polygonal mesh from a perspective of the view and at a resolution specified by the landmark extraction specification. Extracting the one or more landmarks also comprises searching for the one or more landmarks within one or more ranges of points on the 2D outline specified by the landmark extraction specification.

In some embodiments, the mesh editing specification indicates the one or more target physical features by indicating one or more semantic labels of the one or more target physical features.

In some embodiments, the mesh editing specification specifies the way that the one or more target physical features are to be deformed by specifying, for each target physical feature, at least an amount, ratio, or coefficient by which the target physical feature is to be moved or scaled. Alternatively, the mesh editing specification specifies the way that the one or more target physical features are to be deformed by specifying, for each target physical feature, at least an angle by which the target physical feature is to be rotated.

In some embodiments, manipulating the one or more handles comprises re-locating the one or more handles in the 3D polygonal mesh as needed to move, scale, and/or rotate the one or more target physical features to an extent specified by the mesh editing specification. In some embodiments, editing the one or more other parts of the 3D polygonal mesh comprises editing the one or more other parts of the 3D polygonal mesh according to an algorithm specified by the mesh editing specification, constrained by the one or more handles as re-located.

In some embodiments, the method further comprises extracting, as a function of the one or more landmarks, one or more regions of interest from the 3D polygonal mesh according to a region of interest extraction specification that specifies one or more parameters according to which the one or more regions of interest are to be extracted. In some embodiments, each of the one or more regions of interest is a region within which the one or more target physical features are to be deformed. In some embodiments, editing the one or more other parts of the 3D polygonal mesh comprises editing the one or more other parts of the 3D polygonal mesh based on the one or more regions of interest extracted. In one or more of these embodiments, extracting the one or more regions of interest comprise extracting a sub-mesh from the 3D polygonal mesh, or a simplified version thereof, according to the region of interest extraction specification, as a function of the one or more extracted landmarks. Extracting the one or more regions of interest also comprises obtaining the one or more regions of interest from the extracted sub-mesh. In one or more of these embodiments, the region of interest extraction specification specifies a distance threshold. In some embodiments, extracting the sub-mesh comprises extracting the sub-mesh as one or more portions of the 3D polygonal mesh that are located within the distance threshold of one or more extracted landmarks.

In some embodiments, the 3D polygonal mesh is a 3D polygonal mesh of an anatomical object. In some embodiments, the one or more physical features are one or more anatomical features. In some embodiments, the one or more target physical features are one or more target anatomical features. In one or more of these embodiments, the anatomical object includes a head, one or more ears, and/or an upper torso. In one or more of these embodiments, the method further comprises generating, from the edited 3D polygonal mesh, a head-related, HR, transfer function filter personalized to a deformed anatomical object that comprises the anatomical object with the one or more target physical features deformed. In one or more of these embodiments, the method further comprises generating multiple HR transfer function filters personalized to different anatomical objects, by deforming the same 3D polygonal mesh according to multiple different mesh editing specifications that specify different ways to deform the one or more target physical features and/or different target physical features to deform.

Other embodiments herein include computing equipment configured to extract, from the 3D polygonal mesh, one or more landmarks that form one or more physical features specified by a landmark extraction specification. In some embodiments, the landmark extraction specification specifies the one or more physical features by including one or more semantic labels of the one or more physical features. In some embodiments, the one or more semantic labels are associated with one or more parameters according to which the one or more landmarks are to be extracted. The computing equipment is also configured to determine which one or more extracted landmarks form one or more target physical features that a mesh editing specification indicates are to be deformed. The computing equipment is also configured to deform the one or more target physical features in a way specified by the mesh editing specification by manipulating the one or more determined landmarks as one or more handles. The computing equipment is also configured to edit one or more other parts of the 3D polygonal mesh as specified by the mesh editing specification, to account for deformation of the one or more target physical features.

In some embodiments, the computing equipment is configured to perform the steps described above for computing equipment.

Other embodiments herein include a computer program comprising instructions which, when executed by at least one processor of computing equipment, causes the computing equipment to perform the steps described above for computing equipment.

In some embodiments, a carrier containing the computer program is one of an electronic signal, optical signal, radio signal, or computer readable storage medium.

Other embodiments herein include computing equipment. The computing equipment comprises processing circuitry configured to extract, from the 3D polygonal mesh, one or more landmarks that form one or more physical features specified by a landmark extraction specification. In some embodiments, the landmark extraction specification specifies the one or more physical features by including one or more semantic labels of the one or more physical features. In some embodiments, the one or more semantic labels are associated with one or more parameters according to which the one or more landmarks are to be extracted. The processing circuitry is also configured to determine which one or more extracted landmarks form one or more target physical features that a mesh editing specification indicates are to be deformed. The processing circuitry is also configured to deform the one or more target physical features in a way specified by the mesh editing specification by manipulating the one or more determined landmarks as one or more handles. The processing circuitry is also configured to edit one or more other parts of the 3D polygonal mesh as specified by the mesh editing specification, to account for deformation of the one or more target physical features.

In some embodiments, the processing circuitry is configured to perform the steps described above for computing equipment.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of an example of ITD and spectral cues of a sound wave propagating towards a listener.

FIG. 2 shows some anthropometric measurements of an ear.

FIG. 3 is a block diagram of computing equipment configured to deform a three-dimensional (3D) polygonal mesh according to some embodiments.

FIG. 4 is a block diagram of computing equipment according to some embodiments that also exploit region of interest (ROI) extraction.

FIG. 5 is a block diagram of computing equipment that in some embodiments further includes an HR filter generator.

FIG. 6 is a block diagram of computer equipment configured to generate multiple HR filters.

FIG. 7 shows a block diagram of rule-based mesh deformation according to some embodiments.

FIG. 8 is a 3D mesh of head and upper torso of a human subject.

FIG. 9 is a simplified version of the 3D mesh in FIG. 8.

FIG. 10 is a 2D front view outline of the high-resolution 3D mesh shown in FIG. 8.

FIGS. 11A and 11B are diagrams of an example set of landmarks on the left ear.

FIG. 12 is a sub-mesh containing the left ear and part of the left side of the head.

FIG. 13 is a sub-mesh model that is segmented into two regions with one containing the left ear as shown in black and the other one containing the rest as shown in white.

FIG. 14 is the result of segment transfer from the sub-mesh in FIG. 13 to its original high-resolution mesh.

FIG. 15 is a logic flow diagram of a method performed by computing equipment for deforming a 3D polygonal mesh according to some embodiments.

FIG. 16 is a block diagram of computing equipment for deforming a 3D polygonal mesh according to some embodiments.

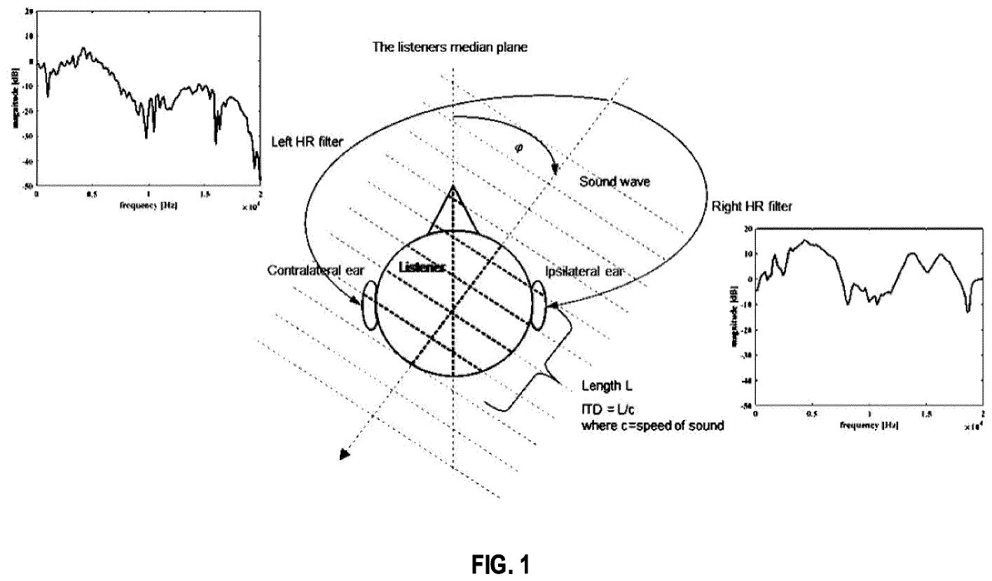

### DETAILED DESCRIPTION

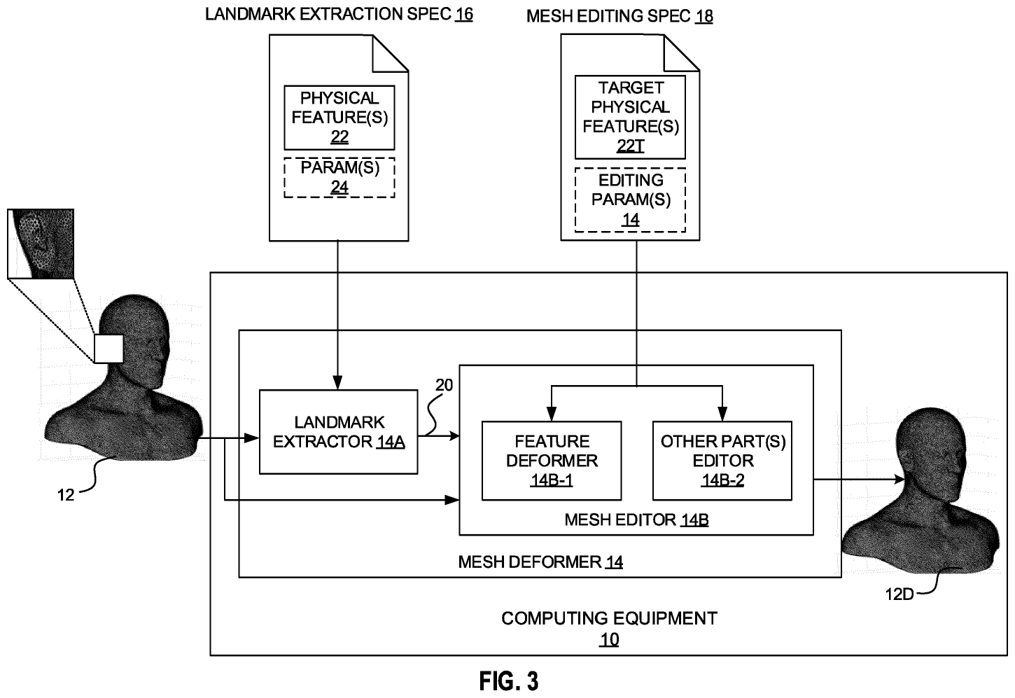

FIG. 3 shows computing equipment 10 configured to deform a three-dimensional (3D) polygonal mesh 12, e.g., representing an anatomical object such as the head, ear(s), and/or upper torso of a human. The computing equipment 10 as shown includes a mesh deformer 14. The mesh deformer 14 deforms the 3D polygonal mesh 12 into a deformed 3D polygonal mesh 12D. The mesh deformer 14 deforms the 3D polygonal mesh 12 in this way according to a landmark extraction specification 16 and a mesh editing specification 18 that collectively specify parameter(s) governing the deformation.

The landmark extraction specification 16 governs landmark extraction performed by a landmark extractor 14A of the computing equipment 10. Landmark extraction extracts landmark(s) 20 from the 3D polygonal mesh 12. The landmark(s) 20 may for example be one or more vertices in the 3D polygonal mesh 12, in which case the landmark extraction specification 16 effectively governs which one or more vertices in the 3D polygonal mesh 12 are to serve as the landmark(s) 20 for the deformation. But, rather than specifying these one or more vertices, the landmark extraction specification 16 according to some embodiments specifies physical feature(s) 22. Here, physical feature(s) 22 are feature(s) of a physical object represented by the 3D polygonal mesh 12, e.g., one or more anatomical features of a human represented by the 3D polygonal mesh 12. Equipped with such a landmark extraction specification 16, the landmark extractor 14A extracts landmark(s) 20 (e.g., one or more vertices in the 3D polygonal mesh 12) that form the physical feature(s) 22 specified by the landmark extraction specification 16. The landmark extractor 14A may for example identify which vertice(s) in the 3D polygonal mesh 12 lie on a boundary formed by the specified physical feature(s) 22, and extract one or more of the identified veritice(s) as the landmark(s) 20.

In some embodiments, the landmark extraction specification 16 specifies the physical feature(s) 22 by including semantic label(s) of the physical feature(s) 22. For example, in order to specify the extraction of landmark(s) 20 that form the height of the pinna of a person's left ear represented in the 3D polygonal mesh 12, the landmark extraction specification 16 may include the semantic label “left pinna height”. As another example, in order to specify the extraction of landmark(s) 20 that form the width of the pinna of a person's left ear represented in the 3D polygonal mesh 12, the landmark extraction specification 16 may include the semantic label “left pinna width”. Regardless, the semantic label(s) may be associated with parameter(s) 24 according to which the corresponding landmark(s) 20 are to be extracted. In one embodiment, the association between the semantic label(s) and the corresponding parameter(s) 24 for landmark extraction is predefined, is computed or looked up, or is provided out-of-band apart from the landmark extraction specification 16. In other embodiments shown, though, the association between the semantic label(s) and the corresponding parameter(s) 24 for landmark extraction is explicitly specified in the landmark extraction specification 16 itself.

In some embodiments, for instance, the parameter(s) 24 according to which the landmark(s) 20 are to be extracted include, for each of the physical feature(s) 22, (i) a view of the 3D polygonal mesh 12 from which a two-dimensional (2D) outline of the 3D polygonal mesh 12 is to be extracted; (ii) a resolution of points that are to form the 2D outline; and/or (iii) a range of points on the 2D outline within which to search for landmark(s) 20 that form the physical feature 22. In this case, then, for each view specified by the landmark extraction specification 16, the landmark extractor 14A may extract a 2D outline of the 3D polygonal mesh 12 from a perspective of the view and at a resolution specified by the landmark extraction specification 16. And then search for the landmark(s) 20 within one or more ranges of points on the 2D outline specified by the landmark extraction specification 16.

The mesh editing specification 18 supplements the landmark extraction specification 16 in the sense that the mesh editing specification 18 governs how a mesh editor 14B of the computing equipment 10 is to edit the 3D polygonal mesh 12 given the landmark(s) 20 extracted, i.e., in order to accomplish deformation of the 3D polygonal mesh 12. The mesh editing specification 18 in this regard specifies one or more target physical features 22T that are to be deformed as part of deforming the 3D polygonal mesh 12. The target physical feature(s) 22T are thereby the target of the 3D polygonal mesh deformation, e.g., in the sense that deformation of the target physical feature(s) 22T is the goal of deforming the 3D polygonal mesh 12. In some embodiments, the target physical feature(s) 22T specified as the target in the mesh editing specification 18 are a subset of the physical feature(s) 22 specified in the landmark extraction specification 16. In these and other embodiments, then, the mesh editing specification 18 may similarly specify the target physical feature(s) 22T by including semantic label(s) for the target physical feature(s) 22T. For example, in order to specify that the height of the pinna of a person's left ear is a target physical feature to be deformed in the 3D polygonal mesh 12, the mesh editing specification 18 may include the semantic label “left pinna height”.

Equipped with the mesh editing specification 18, the mesh editor 14B determines which one or more extracted landmark(s) 20 form the target physical feature(s) 22T that the mesh editing specification 18 indicates are to be deformed. The mesh editor 14B may for instance identify which vertice(s) in the 3D polygonal mesh 12 lie on a boundary formed by the target physical feature(s) 22T, and determine that one or more of the identified vertice(s) are the landmark(s) 20 that form the target physical feature(s) 22T.

A feature deformer 14B-1 then deforms the target physical feature(s) 22T by manipulating the determined landmark(s) as handle(s). The mesh editing specification 18 in this regard specifies the way that the feature deformer 14B-1 is to deform the target physical feature(s) 22T. In some embodiments, for example, the mesh editing specification 18 specifies the way that the target physical feature(s) 22T are to be deformed by specifying, for each target physical feature 22T, (i) an amount, ratio, or coefficient by which the target physical feature 22T is to be moved or scaled; and/or (ii) an angle by which the target physical feature 22T is to be rotated. Regardless, the mesh editor 14B may translate the way that the mesh editing specification 18 specifies for how to deform the target physical feature(s) 22T into the corresponding way that the feature deformer 14B-1 is to manipulate the determined landmark(s) as handle(s), i.e., in order for manipulation of the handle(s) to produce the specified deformation of the target physical feature(s) 22T. The feature deformer 14B-1 in these and other embodiments may manipulate the handle(s) by re-locating the handle(s) in the 3D polygonal mesh 12 as needed to move, scale, and/or rotate the target physical features 22T to the extent specified by the mesh editing specification 18.

After or as part of deforming the target physical feature(s) 22, an other part(s) editor 14B-2 edits other part(s) of the 3D polygonal mesh 12 as specified by the mesh editing specification 18, to account for deformation of the target physical feature(s) 22T. The mesh editing specification 18 in this regard may specify an algorithm, and/or one or more input parameters governing the algorithm, for how other part(s) of the 3D polygonal mesh 12 as to be modified to account for deformation of the target physical feature(s) 22T. The other part(s) editor 14B-2 may for example edit the other part(s) of the 3D polygonal mesh 12 according to the algorithm, constrained by the handle(s) as re-located for deformation of the target physical feature(s) 22T.

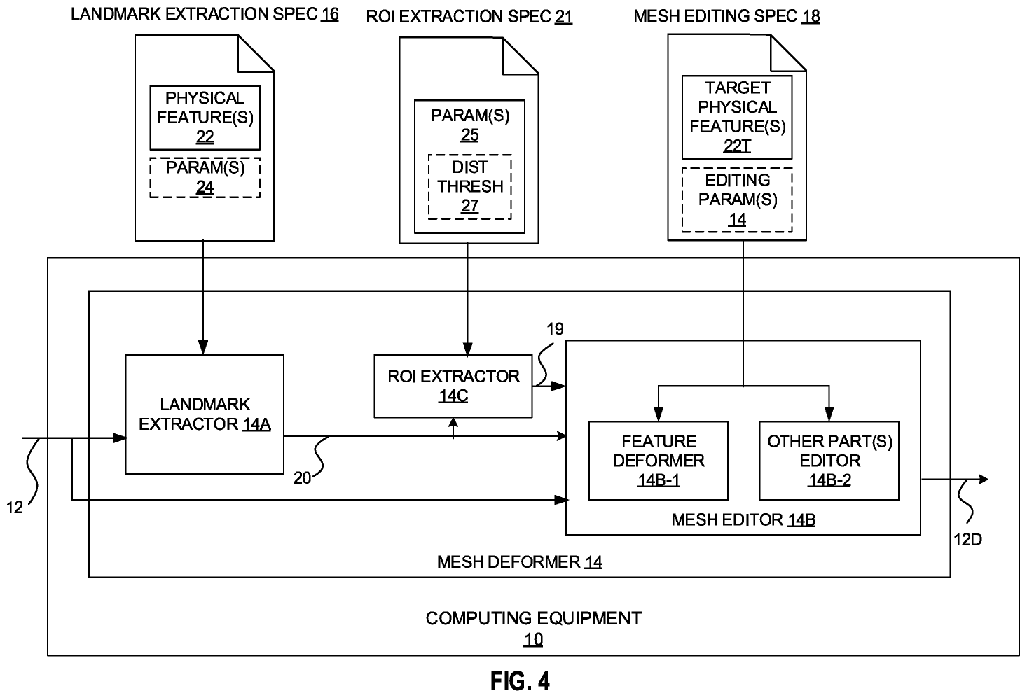

FIG. 4 illustrates additional details of the mesh deformer 14 according to other embodiments that also exploit region of interest (ROI) extraction. As shown, the mesh deformer 14 further comprises an ROI extractor 14C. The ROI extractor 14C extracts, as a function of the landmark(s) 20, one or more regions of interest 19 from the 3D polygonal mesh 12 according to an ROI extraction specification 21. The ROI extraction specification 21 specifies one or more parameters 25 according to which the one or more regions of interest 19 are to be extracted. Here, each region of interest 19 is a region within which the target physical feature(s) 22T are to be deformed.

In some embodiments, for example, the ROI extractor 14C extracts a sub-mesh from the 3D polygonal mesh 12, or a simplified version thereof, according to the ROI extraction specification 21, as a function of the extracted landmark(s) 20. The ROI extractor 14C in this case obtains the one or more regions of interest 19 from the extracted sub-mesh. Where, for instance, the ROI extraction specification 21 specifies a distance threshold 27 as shown in FIG. 4, the ROI extractor 14C may extract the sub-mesh as one or more portions of the 3D polygonal mesh 12 that are located within the distance threshold 27 of one or more extracted landmark(s) 20.

Regardless, with the one or more regions of interest 19 extracted, the mesh editor 14B edits 3D polygonal mesh 12 based also on the region(s) of interest 19. For example, the other part(s) editor 14B-2 may edit the other part(s) of the 3D polygonal mesh 12 based on the one or more regions of interest 19 extracted.

Note that, although the landmark extraction specification 16, the ROI extraction specification 21, and the mesh editing specification 18 have been described as different specifications, two or more of the specifications 16, 18, 21 in practice may be combined or be part of the same data structure, e.g., so as to be sub-specifications of the same common specification. Either way, the content of the landmark extraction specification 16 governs landmark extraction, the content of the mesh editing specification 18 governs editing of the 3D polygonal mesh 12 using the extracted landmark(s) 20, and the content of the ROI extraction specification 21 governs ROI extraction.

Note, too, that the specification(s) 16, 18, 21 may be embodied in any file or data structure capable of capturing and/or conveying specifics for governing deformation of the 3D polygonal mesh 12 as described above.

Generally, then, some embodiments herein parameterize 3D polygonal mesh deformation in a way that enables the deformation to be performed according to specification, e.g., specification(s) 16, 18, and/or 21. For example, some embodiments herein perform 3D polygonal mesh deformation according to specification of which target physical feature(s) 22T represented in the 3D polygonal mesh 12 are to be deformed and how those target physical feature(s) 22T are to be deformed. Such specification may for instance just generally specify semantic label(s) of the physical feature(s) 22T to be deformed and measure(s) by which the physical feature(s) 22T are to be moved, scaled, and/or rotated. With the physical feature(s) 22T targeted for deformation specified in this way, some embodiments decipher which landmark(s) 20 (e.g., vertice(s)) in the 3D polygonal mesh 12 form those target physical feature(s) 22T and then manipulate the identified landmark(s) 20 as handles in order to deform the target physical feature(s) 22T according to specification.

By providing 3D polygonal mesh deformation according to specification, some embodiments herein are able to generate a large number of 3D polygonal meshes by deforming a small number of 3D polygonal meshes according to different specifications. Some embodiments are able to do so even for 3D meshes of small, complex areas, such as the ear, head, and/or upper torso. Correspondingly, then, some embodiments herein are applicable for generating a large number of head-related (HR) filters that are personalized for a corresponding large number of listeners, e.g., as represented by different deformations of a small number of 3D polygonal meshes of the ear, head, and/or upper torso.

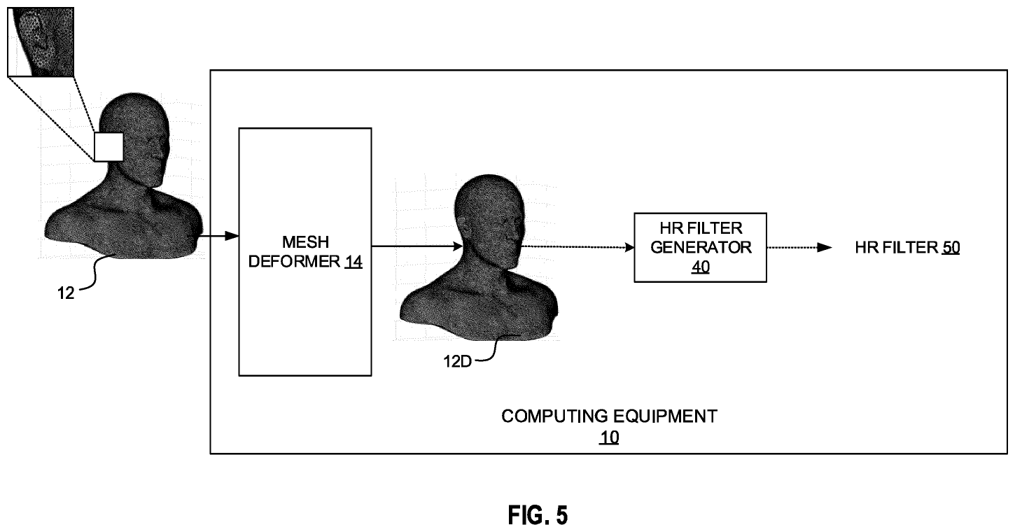

FIG. 5 for example shows that the computing equipment 10 in some embodiments further includes an HR filter generator 40. The HR filter generator 40 generates an HR filter 50 as a function of the deformed 3D polygonal mesh 12D output from the mesh deformer 14 described above. With the HR filter 50 generated based on the deformed 3D polygonal mesh 12D, the HR filter 50 is effectively personalized, individualized, and/or otherwise tailored to that deformed 3D polygonal mesh 12D. The deformed 3D polygonal mesh 12D may represent deformation of an anatomical object, e.g., the anatomical object with the target physical feature(s) 22T deformed, such as a deformed ear, head, and/or upper torso.

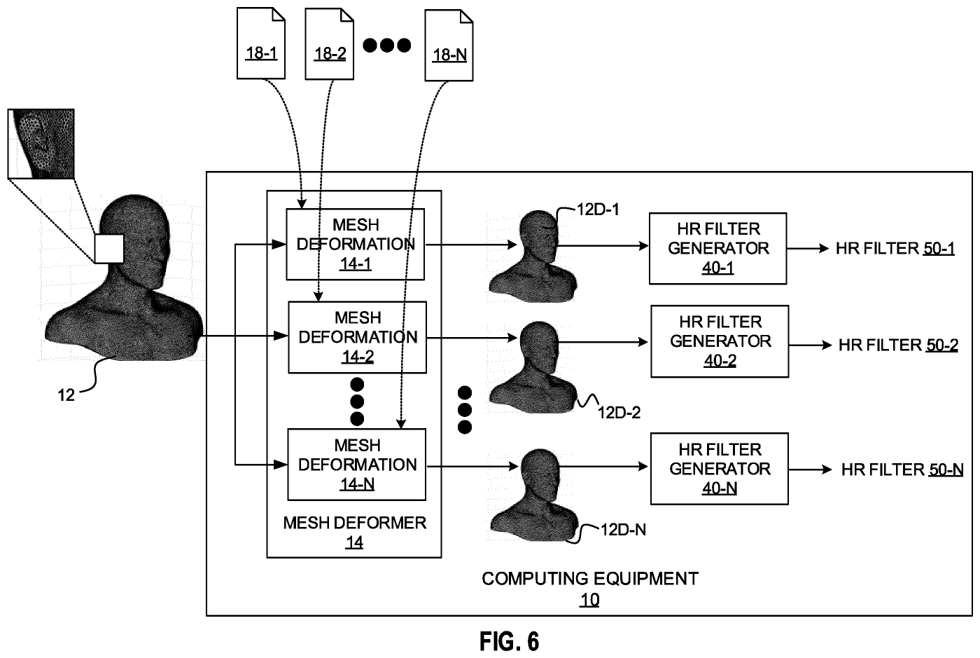

The computing equipment 10 in some embodiments generates the HR filter 50 in this way as part of generating multiple HR filters personalized to different anatomical objects. FIG. 6 shows one example. As shown, the computing equipment 10 deforms the same 3D polygonal mesh 12 with N different instances of mesh deformation 14-1, 14-2 . . . 14-N (with each instance represented in FIG. 3). The different instances of mesh deformation 14-1, 14-2 . . . 14-N deform the 3D polygonal mesh 12 according to different respective mesh editing specifications 18-1, 18-2, . . . 18-N. The different respective mesh editing specifications 18-1, 18-2, . . . 18-N may for example specify different ways to deform the target physical feature(s) 22T and/or specify different target physical feature(s) 22T to deform. Collectively, then, the N different instances of mesh deformation 14-1, 14-2 . . . 14-N produce N different deformations 12D-1, 12D-2, . . . 12D-N of the 3D polygonal mesh 12. Correspondingly, the computing equipment 10 implements N different instances 40-1, 40-2, . . . 40-N of an HR filter generator that respectively generate N HR filters 50-1, 50-2, . . . 50-N from the N different deformations 12D-1, 12D-2, . . . 12D-N of the 3D polygonal mesh 12.

Some embodiments herein thereby provide a fully automated rule-based method for 3D mesh deformation that can be used to generate an arbitrarily large number of desired 3D meshes. Some embodiments automatically identify manipulation handles and automatically extract ROI(s). In some embodiments, the 3D mesh deformation is then induced by manipulating the handles through control parameters.

Some embodiments are advantageous in that they automatically define ROI based on the semantic instance that are aimed to deform and/or automatically manipulate handles through control parameters.

Consider now additional details of some example embodiments that perform rule-based 3D mesh deformation to produce an arbitrarily large number of 3D meshes of ear, head, and/or upper torso with desired anthropometric features. The deformation in this example is operated over an intrinsic surface representation (See Sorkine, et al.) based on the Laplacian of a mesh so that the reconstruction of the global coordinates preserves local geometric details of the surface as much as possible. The deformation consists of manipulating handles with each being a set of vertices that can be moved, rotated, and scaled. The manipulation handles are a sub-set of landmark(s) 20 that are extracted according to landmark extraction rules embodied in the landmark extraction specification 16, e.g., as specified by a user. The manipulation of the handles is controlled by the mesh editing specification 18, e.g., containing user-specified control rules. The manipulation of the handles induces a global deformation within the sub-mesh of the ROI. Given the full set of the landmark(s) 20, the ROI is extracted using a mesh segmentation technique according to the ROI extraction specification 21, e.g., embodying user-specified ROI extraction rules. The deformation is achieved by a mesh editing algorithm according to the mesh editing specification 18, e.g., embodying user-specified deformation rules.

Consider as a pre-requisite, notation and variable definition. General data structures are denoted as lists of data sequences and other data structures. A basic 3D mesh is represented by a 3D mesh model [symbol] , which is provided in the form of the data list. In this description, a vertex-face representation is considered, where [symbol] ={V, F}.

V={vₓ, v_{y}, v_{z}} describes the geometric positions of the vertices in [symbol] ³, where vₓ=[vₓ[1], . . . , vₓ[i], . . . , vₓ[I]] contains the x-coordinates of the vertices, v_{y}=[v_{y}[1], . . . , v_{y}[i], . . . , v_{y}[I]] contains the y-coordinates of the vertices, v_{z}=[v_{z}[1], . . . , v_{z}[i], . . . , v_{z}[I]] contains the z-coordinates of the vertices, and I is the total number of vertices.

F={fₘ:m=1, . . . , M} describes the connectivity how the M-gon faces are constructed from vertices, where fₘ=[fₘ[1], . . . , fₘ[n], . . . , fₘ[N]], fₘ[n] is the index of a vertex that forms the m-th side of the n-th face, N is the total number of faces, and M is the number of sides of a face.

A 2D outline is provided in the form of a data list of coordinates [symbol] , which contains at least two elements corresponding to two of the x-, y-, and z-coordinates of the extracted outline points according to the 2D view, denoted by X₁, Y₁ and Z₁, respectively. Additionally, [symbol] may also contain supplement information, which may be represented by at least one of the x-, y-, and z-coordinates regarding the extracted outline points, denoted by X₂, Y₂, and Z₂. The dimension of each element in [symbol] depends on the 2D view of the outline and the total number of points that the outline may have.

A set of landmarks is provided in the form of data list of vertices and physical measurements [symbol] ={V_{L}, [symbol] }, where V_{L}={v_{Lx}[l], v_{Ly}[l], v_{Lz}[l]:l=1, . . . , L} describes the x-, y-, and z-coordinates of the vertices of the landmarks, L is the total number of landmarks, [symbol] is a vector of length A describing the physical measurements of anthropometric features, and A is the number of anthropometric features.

A set of clusters of segments is provided in the form of the data list C={ [symbol] [n]:n=1, . . . , N}, where [symbol] [n]∈[1, N_{c}] is the index of cluster of the n-th face, N is the total number of faces of the mesh to be segmented, and N_{C} is the number of segments.

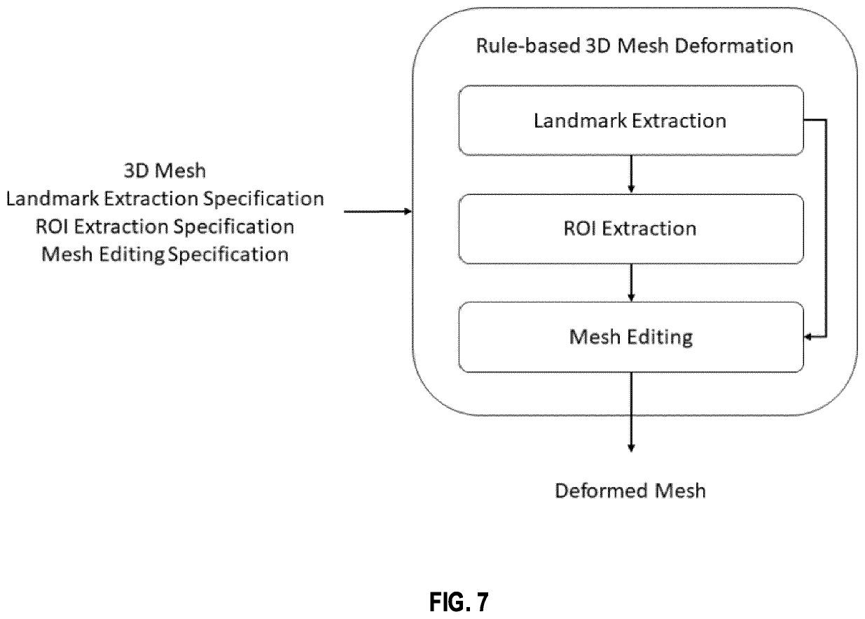

FIG. 7 shows a block diagram of rule-based mesh deformation according to some embodiments. The rule-based mesh deformation is shown as being performed by three processing modules, i.e., Landmark Extraction, ROI Extraction, and Mesh Editing.

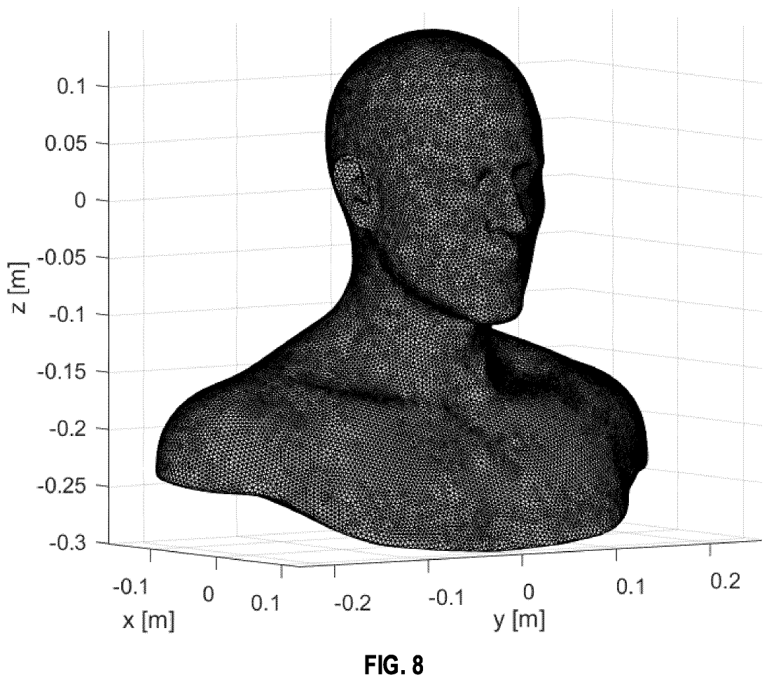

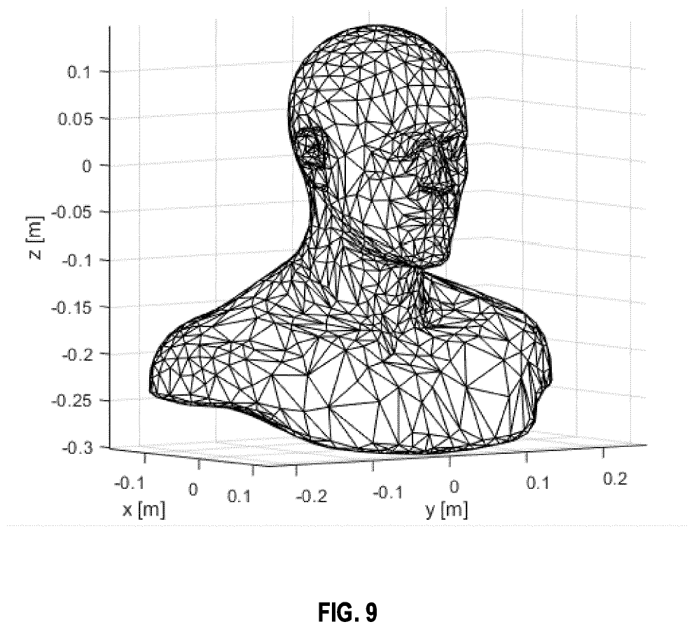

The rule-based mesh deformation operates on the original mesh model [symbol] _{O}, exemplifying the 3D polygonal mesh 12 in FIG. 3. [symbol] _{O} may be obtained by loading a 3D mesh model from an existing file, e.g., a 3D mesh in PLY format or STL format, into [symbol] _{O}. An example of a 3D mesh of head and upper torso of a human subject is shown in FIG. 8, with FIG. 9 showing a simplified version of that mesh, The mesh consists of triangle faces, and the coordinate system follows the right-hand rule.

Landmark Extraction Module. The purpose of landmark extraction is to identify critical points that lie on the boundary of the region(s) to deform. The critical points are a group of vertices within which all or some of them will serve as manipulation handle(s). The inputs to the landmark extraction module are the original mesh model [symbol] _{O} and the landmark extraction specification [symbol] _{LE}. Its output is a set of landmarks [symbol] , where [symbol] here exemplifies the extracted landmark(s) 20 in FIG. 3.

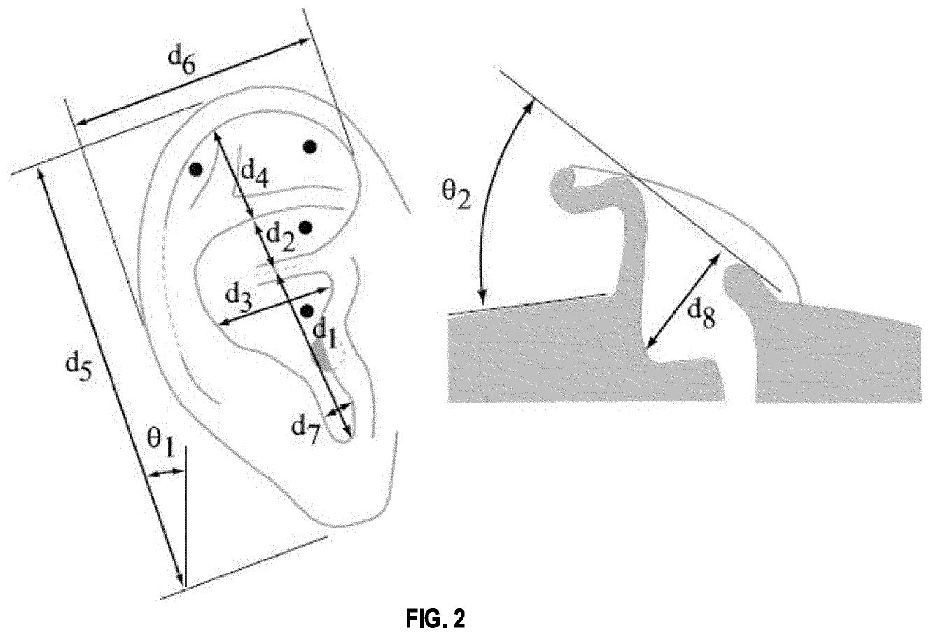

The landmark extraction specification 16 from FIG. 3 is exemplified here as [symbol] _{LE}={ [symbol] , [symbol] _{L}}. The landmark extraction specification in this example specifies a list of physical features [symbol] , including the features to be deformed and/or additional features. Such features can be, e.g., one or some of the anthropometric features shown in FIG. 2. The landmark extraction specification in this example also specifies [symbol] _{L} describing parameter(s) for landmark extraction corresponding to the specified physical features [symbol] . The parameter(s) may contain, for example, (i) [symbol] specifying the view of the 2D outline to be extracted; (ii) Δ specifying a resolution of the outline points; and/or (iii) ε specifying search ranges of landmarks. Note here that parameter(s) may generally encompass rule(s).

An example landmark extraction specification in this regard may be:
[symbol] ={‘left pinna height’, ‘left pinna width’} (d5, d6 in FIG. 2)
[symbol] ={‘front-view’, ‘left-side-view’}
Δ={0.75e-3, 0.25e-3} (default values to extract head outline, ear outline)
ε={−0.5, 0.5} (an example of default values to set the search range to find the ear location points for front view and later used as a landmark indicating the bottom of left ear)

ROI Extraction. The purpose of ROI Extraction is to identify the ROIs 19, within which the shape will be deformed induced by the manipulation of handles. Its inputs are the original mesh [symbol] _{O}, the ROI extraction specification [symbol] _{RE}, the landmarks [symbol] . Its output is ROIs C_{R}, which exemplifies the ROI(s) 19 in FIG. 4.

The ROI extraction specification [symbol] _{RE}={ [symbol] _{S}, [symbol] _{C}} exemplifies the ROI extraction specification 21 in FIG. 4. In this example, the ROI extraction specification [symbol] _{RE}={ [symbol] _{S}, [symbol] _{C}} specifies (i) [symbol] _{S} describing the parameters (e.g., rules) for mesh simplification; and (ii) [symbol] _{C} describing the parameters (e.g., rules) for clustering.

In some embodiments [symbol] _{S} may contain [symbol] _{S} indicating if a mesh simplification is needed, which may be an ON/OFF flag or a threshold specifying the target number of faces in the simplified mesh. Alternatively or additionally, [symbol] _{S} may contain [symbol] _{Sub} specifying adaptive rules related to segmenting a portion of a mesh to obtain a sub-mesh that only contains the part corresponding to the targeted semantic instance specified in [symbol] and part of its vicinity (e.g., the faces that lie inside a sphere centered at a reference handle with a radius of threshold, where the threshold may be adaptively computed). Alternatively or additionally, [symbol] _{S} may contain [symbol] describing an algorithm for mesh simplification associated with required parameters.

In some embodiments, [symbol] _{C} may contain N_{C} specifying the number of clusters, where a 3D mesh is decomposed into a set of meaningful segments. Alternatively or additionally, [symbol] _{C} may contain [symbol] describing an algorithm for a mesh segmentation associated with required parameters.

An example ROI extraction specification may include:
[symbol] _{S}=1/0 (enable mesh simplification/disable mesh simplification)
[symbol] _{Sub}=2/3 (default value to calculate a threshold for extracting a sub-mesh)
[symbol] =method: ‘Surface simplification using quadric error metrics’; parameter: target number of faces=3000 from which calculates the simplification percentage
N_{C}=2 (head and ear)
[symbol] =method: ‘Segmentation of 3D Meshes through Spectral Clustering’; parameters: {0.3, 0.2} to calculate the affinity matrix

Note that the mesh segmentation may be applied directly on the original mesh, or a simplified mesh, or a sub-mesh extracted from either the original mesh or the simplified mesh. If the initial segments are obtained on a simplified mesh or a sub-mesh, the segments need to transfer to the original mesh.

Mesh Editing. The inputs to the mesh editing module are the extracted landmarks [symbol] , the ROIs C_{R}, and the deformation specification [symbol] _{ME}. The deformation specification [symbol] _{ME} is an example of the mesh editing specification 18 in FIG. 3. The output of the mesh editing module is the deformed mesh 12D.

In some embodiments, the deformation specification [symbol] _{ME}={ [symbol] _{D}, [symbol] _{D}, [symbol] } specifies [symbol] _{D} describing the parameters (e.g., rules) for mesh editing, [symbol] _{D} describing handles' control parameters, and/or [symbol] describing an algorithm for mesh editing associated with required parameters.

With regard to [symbol] _{D}, [symbol] _{D} may for example specify if a transition region between the ROI and the stationary region is required to achieve a seamless transition with gradual change of detail between the two regions and a parameter specifying the size of the transition region.

With regard to [symbol] _{D}, [symbol] _{D} may contain [symbol] _{D}⊆ [symbol] specifying physical features to deform and/or [symbol] specifying the level of deformation of each feature in [symbol] _{D}, e.g., the level of a feature to be enlarged or shrunk.

An example mesh editing specification may include:
[symbol] _{D}={1/0. 0.1/−} (find stationary anchors/do not need stationary anchors, a threshold to find stationary anchors)
[symbol] _{D}={‘left pinna width’}
[symbol] ={measures to deform, deform coefficient, rotation angle if possible} ({to construct a matrix showing landmarks to be deformed, the level of deformation, an angle how much the ear is to be rotated when the editing algorithm allows})
[symbol] =method: ‘Laplacian surface editing’; parameters: rotation 1/0 (rotation is allowed/rotation is not allowed) (Laplacian surface editing is able to do the rotation operation)
   Table 1 below shows a step-by-step process for rule-based, controllable 3D Mesh Deformation according to some embodiments.

TABLE 1

Input
Original 3D mesh M₀
Landmark extraction specification [symbol] _{LE}
ROI extraction specification [symbol] _{RE}
Mesh editing specification [symbol] _{ME}
Landmark Extraction
Obtain a 2D outline [symbol] of the 3D mesh [symbol] _{O} according to [symbol] _{L}
Obtain a set of landmarks [symbol] given [symbol]
ROI Extraction
Obtain a simplified mesh [symbol] _{S} of [symbol] _{O} according to [symbol] _{S}
Obtain a sub-mesh [symbol] _{sub} of [symbol] _{S} or [symbol] _{O} given [symbol] according to [symbol] _{S}
Obtain a set of clusters of segments C_{S} according to [symbol] _{C}
Obtain ROIs C_{R} given C_{S}
Mesh Editing
Obtain stationary anchors V_{A} given C_{R} according to [symbol] _{D}
Obtain a set of manipulation handles H given [symbol] according to [symbol] _{D}
Obtain a deformed mesh [symbol] _{D} according to D

The inputs are obtained, namely the original mesh model [symbol] _{O}, the landmark extraction specification [symbol] _{LE}, the ROI extraction specification [symbol] _{RE}, and the mesh editing specification [symbol] _{ME}. With these inputs, the three processing modules, i.e., Landmark Extraction, ROI Extraction, and 3D Mesh Editing execute.

### Landmark Extraction

Given the user-specified physical features [symbol] and the chosen rules and/or parameters specified in [symbol] _{L}, for each physical feature, a set of landmarks [symbol] are extracted from [symbol] _{O}.

Two steps are involved: (1) Obtain a 2D outline [symbol] of the 3D mesh [symbol] _{O} according to [symbol] _{L}; and (2) Obtain a set of landmarks [symbol] given [symbol] .

### Obtain a 2D Outline of the 3D Mesh _{O} Given

The general principal for extracting 2D outline of a 3D mesh model is to apply a judgment to each edge while iterating over all edges of the model.

According to the view of the outline, [symbol] , specified in [symbol] _{L}, a 2D outline is extracted. Take front view outline as an example. In one embodiment, it may be obtained by slicing [symbol] _{O} with a horizontal plane along z-coordinate and finding the maximum and/or minimum y-values at each z-value, which are the left outline points and/or the right outline points, respectively. The slicing resolution along z-axis can be automatically determined based on the resolution of [symbol] _{O} or provided as a user-specified parameter Δ in [symbol] _{L}.

In another embodiment, to cope with high-resolution mesh, an advanced search algorithm may be preferred, e.g., building a binary search tree for the z-coordinate to find faces that intersect with the horizontal slicing plane. The intersecting faces may be one of the types as following:
a) No vertex intersects the slicing plane while two edges do.
b) One vertex intersects the plane while no edge does.
c) One vertex and one edge intersect the plane.
d) Two vertices and the edge between them intersect the plane.
e) All three vertices and edges intersect the plane.

Go through the intersecting faces and find the vertices that either intersect the plane (e.g., vertices in type b, d, and e), or can be used to interpolate (e.g., two vertices of one edge as in type a and c) to obtain new vertices that represent the intersecting edges.

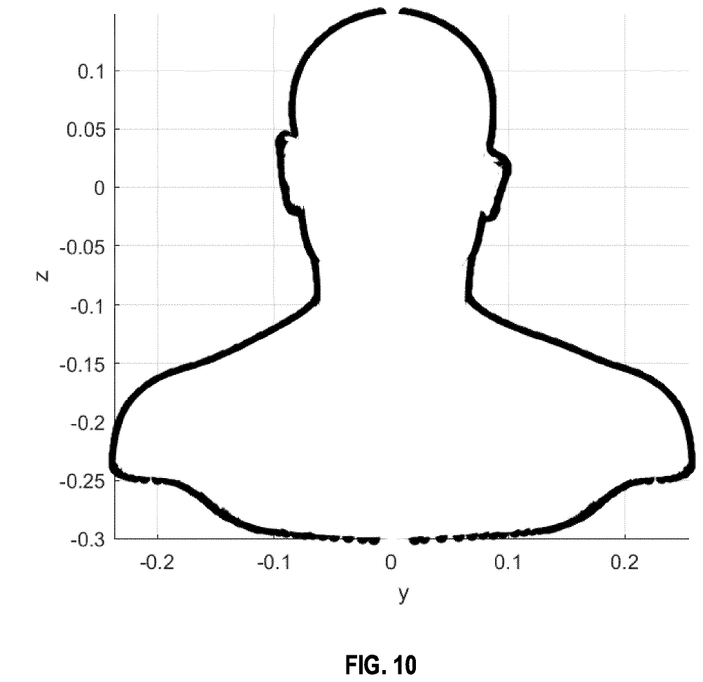

From the intersecting vertices, the maximum and/or minimum y-coordinate values are found at each slicing planes alone the z-axis corresponding to the left outline points and the right outline points, respectively. FIG. 10 shows an example of a 2D front view outline of the high-resolution 3D mesh shown in FIG. 8.

For a 2D front view, the outline may be in form of [symbol] _{F}={Y_{F1}, Z_{F1}, X_{F2}}. Y_{F1} may be a 1- or 2-dimensional vector of length N_{O} with the first dimension corresponding to the y-coordinate values of the left outline points and, when it applies, the second dimension the y-coordinate values of the right outline points. Z_{F1} is a vector of length [symbol] is the total number of the slicing planes alone z-axis determined by the resolution specified in Δ. Optionally, to retrieve the 2D outline points back to the positions in its original 3D mesh, a supplement information is provided in X_{F2}, which has the same dimensionality as Y_{F1} and describes the x-coordinates of the left and the right outline points.

As for another example, if a 2D side view outline is needed, from the intersecting vertices, the minimum and maximum x-coordinate values can be found at each slicing planes alone the z-axis corresponding to the back outline points and the front outline points, respectively. Accordingly, the 2D side view outline may be in the form of [symbol] _{S}={X_{S1}, Z_{S1}, Y_{S2}}.

### Obtain a Set of Landmarks Given

In general, the landmark 3D coordinates can be obtained based on identifying local maxima and local minima on the [symbol] , which may be within certain search range [symbol] specified in [symbol] _{L}. After then, each of the landmark 3D coordinates is quantized to its closest vertex on [symbol] _{O} and obtain V_{L}. Given the landmark vertices, the physical measurement of each anthropometric feature in [symbol] is computed and [symbol] is obtained. Let [symbol] denote the set of landmarks, [symbol] ={V_{L}, [symbol] }, where V_{L}={v_{Lx}[l], v_{Ly}[l], v_{Lz}[l]: l=1, . . . , L} describes the x-, y-, and z-coordinates of the vertices of the landmarks, L is the total number of landmarks, [symbol] is a vector of length A describing the physical measurements of anthropometric features specified in [symbol] , and A is the number of anthropometric features.

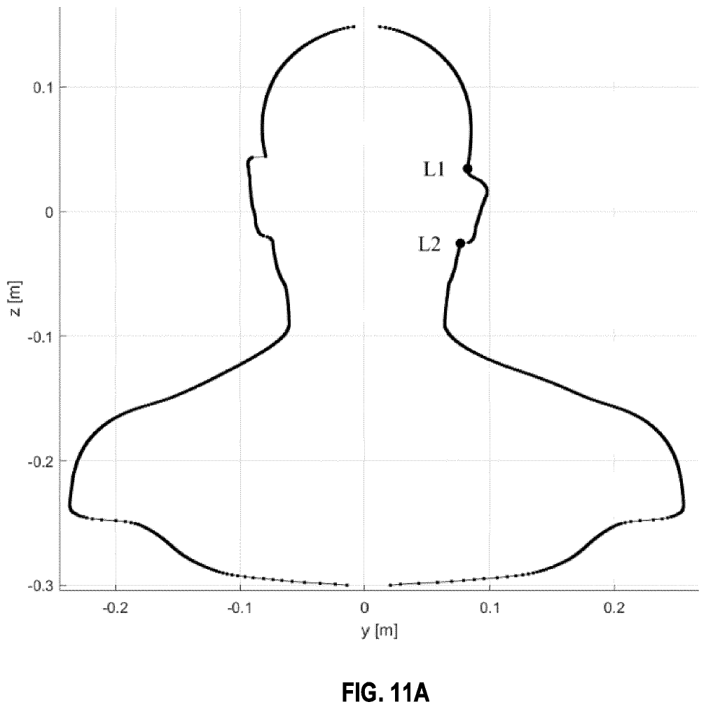

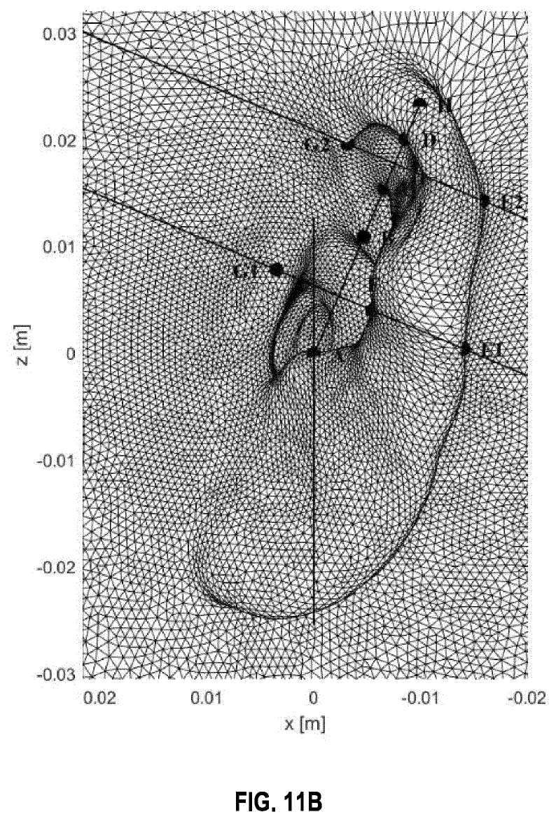

Landmark extraction algorithms can be very much use-case dependent. FIGS. 11A and 11B show an example of a set of landmarks on the left ear using the algorithm presented in Dinakaran et al., “Extraction of anthropometric measures from 3D-meshes for the individualization of head-related transfer functions,” in AES 140th Convention, Paris, France, June 2016. From the vertices of landmarks, pinna width can be computed as the maximum distance between E1 and G1 or E2 and G2; cavum concha height is the distance between A and B; cymba concha height is the distance between B and C; cavum concha width is the distance between F and G1; fossa height is the distance between C and D; and pinna height can be computed as the difference of the z-coordinates between L1 and L2.

### ROI Extraction

ROI extraction is achieved by mesh segmentation techniques. The algorithm required for the mesh segmentation is often computationally expensive, and thus, simplifying the mesh model [symbol] _{O} is of interest. To further reduce the computational cost, a sub-mesh model may be extracted from the simplified mesh model. However, mesh simplification and sub-mesh extraction are not prerequisite for mesh segmentation.

Multiple steps may be involved for mesh segmentation: (1) Obtain a simplified mesh model [symbol] _{S} of [symbol] _{O} according to [symbol] _{S}; (2) Obtain a sub-mesh model [symbol] _{Sub} of [symbol] _{S} or [symbol] _{O} given [symbol] according to [symbol] _{S}; (3) Obtain a set of clusters of segments C_{S} according to [symbol] _{C}; and (4) Obtain ROIs C_{R} given C_{S}.

### Obtain Simplified Mesh of According to

The information indicating if a mesh simplification is needed is given in [symbol] _{S}. If mesh simplification is needed, a simplified mesh model [symbol] _{S}={V_{S}, F_{S}} from [symbol] _{O} is then obtained using an algorithm specified in [symbol] .

Embodiments herein may exploit any suitable algorithm for surface simplification of polygonal models. The result shown in FIG. 9 is obtained by iteratively contracting a pair of vertices with a single vertex based on minimizing the introduced error (See Garland et al., “Surface simplification using quadric error metrics,” in The 24th annual conference on Computer graphics and interactive techniques, Los Angeles, US, 1997).

### Obtain a Sub-Mesh Model of or Given According to

A sub-mesh model [symbol] may be further extracted from [symbol] _{S}, or may be directly extracted from the original mesh model [symbol] _{O}. A thresholding method is one of the simple methods for sub-mesh extraction. A threshold ξ can be a user-specified parameter provided in [symbol] _{sub}.

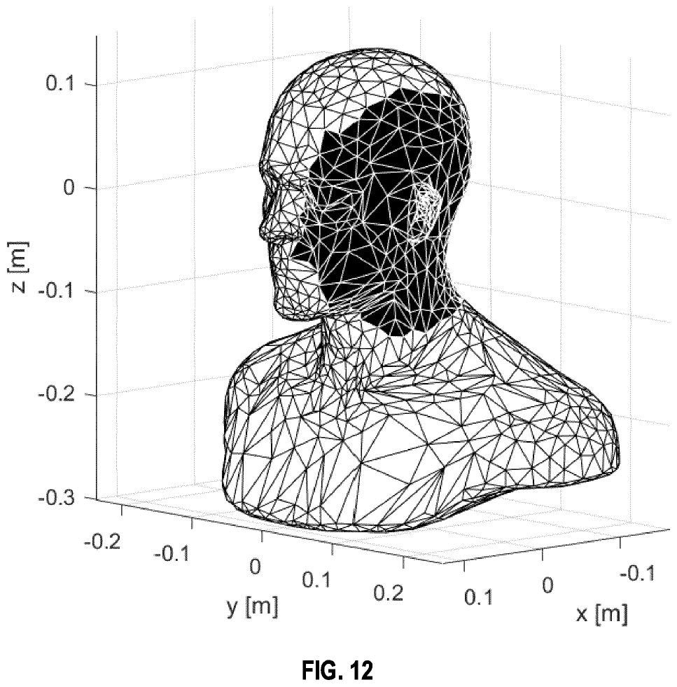

The sub-mesh may contain the part corresponding to the targeted semantic instance specified in [symbol] and part of its vicinity. In an example where the pinna width of left ear of a human subject is to be deformed, the sub-mesh contains the left ear and part of the left side of the head. In this case, the reference landmark may be located at the ear canal. Then the distance from the reference landmark to every face is calculated and compared with the threshold ξ. The faces with the distance below ξ belong to the sub-mesh. The threshold may be adaptively computed based on the distance between the left- and the right-ear canal landmarks. FIG. 12 shows an example of a sub-mesh containing the left ear and part of the left side of the head. In this case, [symbol] ={ [symbol] _{Sub}, [symbol] }, where [symbol] ={ [symbol] [n]=0 or 1, n=1, . . . , N_{Sub}} describing the relationship between [symbol] _{Sub} and [symbol] _{S} (or [symbol] _{O}). The faces in [symbol] _{S} (or [symbol] _{O}) with [symbol] [n]=1 belong to the sub-mesh model [symbol] _{Sub}. N_{Sub}=N_{S} or N_{O} for [symbol] _{S} or [symbol] _{O} being the parent mesh of [symbol] _{Sub}, respectively.

### Obtain a Set of Clusters of Segments C_{S} According to

A set of clusters of segmentation C_{S} is obtained according to the algorithm [symbol] specified in [symbol] _{C}.

Embodiments herein may exploit any suitable 3D mesh segmentation technique. The choice of segmentation algorithm [symbol] may depend on the application. A perception-based mesh segmentation algorithm using spectral clustering method is one possible algorithm applicable for some embodiments herein. The details of this algorithm can be found in Liu et al., “Segmentation of 3D Meshes through Spectral Clustering,” in The 12th Pacific Conference on Computer Graphics and Applications, Seoul, South Korea, 2004. The algorithm contains three main tasks: construct an Affinity Matrix, perform Principal Component Analysis (PCA), and perform K-means clustering.

What is worth of meaning is the construction of the Affinity Matrix. The Affinity Matrix W is a symmetric matrix that encodes the structural information of the mesh that reflects how the faces are correlated with one another in terms of spatial inter-distance (geodesic distance) and orientation (angular distance). Each entry of W reads

$$W [ n , {n}^{′} ] = {e}^{- dist ( n , {n}^{′} ) / 2 {σ}^{2}} , n , {n}^{′} = 1 , … , N .$$

N is the total number of faces in the mesh to be segmented.

σ represents the width for segmentation. It may be chosen to be an average of the distance measure,

$$\frac{1}{{N}^{2}} {\sum }_{n} {\sum }_{{n}^{′}} ,$$

dist(n, n′).

dist(n, n′) defines the distance accounting for both the geodesic and the angular distances between mesh faces,

$$dist ( n , {n}^{′} ) = δ {λ}_{geo} ( n , {n}^{′} ) / {μ}_{geo} + ( 1 - δ ) {λ}_{ang} ( n , {n}^{′} ) / {μ}_{ang} .$$

The δ parameter controls the contribution of the geodesic distance relatively to the angular one for the mesh segmentation. In most cases, angular distance plays more crucial role in the perception-based segmentation, and thus, δ is usually below 0.5.

The geodesic distance λ_{geo} accounts for the geometry distance, which is computed between each pair of adjacent faces as the sum of the distances of each face's center and the middle of their common edges normalized by its average μ_{geo}.

The angular distance λ_{ang} accounts for the minima rule, which states that human vision defines part boundaries along negative minima of principal curvatures, so that faces separated by deep concave regions are considered further apart and are less likely to be grouped into the same patch. λ_{ang} is computed as (1−cos θ) when two adjacent faces form a concave surface or η(1−cos θ) when two adjacent faces form a convex surface normalized by its average μ_{ang}. θ is the angle between the faces' normal vectors. Smaller angles lead to smaller angular distance. η is a parameter used to scale down the angular distance between a pair that forms convex surface. A small η value favorites segmenting on concavity, e.g., within the interval [0.1,0.2].

After performing PCA and K-means clustering, C_{S} is initially obtained and C_{S}={ [symbol] _{S}[n]∈[1, N_{C}]:n=1, . . . , N_{Seg}}, where [symbol] _{S} is the index of cluster for each face and N_{Seg} is the total number of faces in the mesh. If the segmentation is directly applied on [symbol] _{O}, N_{Seg}=N_{O} which is the total number of faces in [symbol] _{O} and there is no update in C_{S}.

As aforementioned, to reduce the computational cost when segmenting a high-resolution 3D mesh, the original mesh model may be simplified, and a sub-mesh model is further extracted from the simplified mesh model. In this case, the segments need to transfer from the sub-mesh to the simplified mesh model then to the original mesh model.

Transferring the segments from the sub-mesh model to its parent mesh model (may be the original mesh model or the simplified mesh model) may be performed based on a one-to-one mapping [symbol] between faces in the sub-mesh model and its parent mesh model.

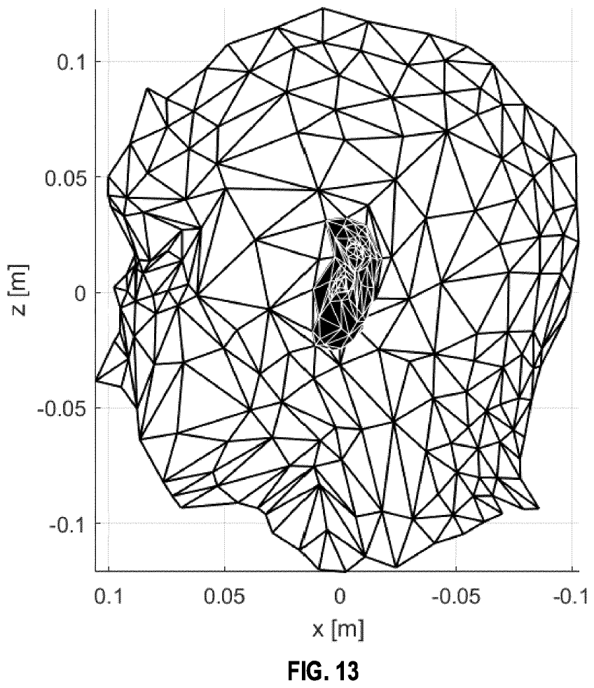

Transferring segments from [symbol] _{S} onto the original mesh [symbol] ₀ may be use the k-nearest neighbors (k-NN) algorithm. FIG. 13 shows the result transferring the segments onto [symbol] ₀ using 1-nearest neighbor algorithm where the distance measure is the Euclidean distance [symbol] (n, n′) between the centers of a pair of faces, the n-th face in F_{O} and the n′-th face in F_{S}. The index of cluster for the n-th face in F_{O} is then

$${S \_ {0}_{}}_{} [ n ] = {S}_{} [ \hat{n} ] ,$$

where

$$\hat{n} = {argmin}_{1 \leq {n}^{′} \leq {N}_{Seg}} ( n , {n}^{′} ) .$$

Then, C_{S} is updated to

$${C}_{S} = \{ {S \_ {0}_{}}_{} [ n ] ∈ [ 1 , {N}_{C} ] : n = 1 , … , {N}_{O} \} .$$

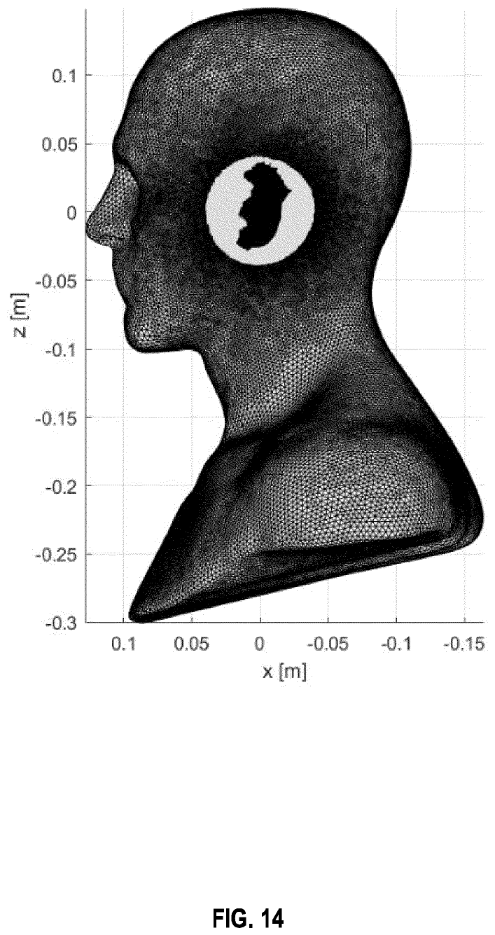

FIG. 13 illustrates that a sub-mesh model that is segmented into two regions with one containing the left ear as shown in black and the other one containing the rest as shown in white. The result of segment transfer from the sub-mesh to its original high-resolution mesh is shown in FIG. 14.

### Obtain ROIs C_{R} Given C_{S}

ROIs may be obtained given C_{S}. The ROIs are basically the segments corresponding to the regions that are subject to deformation. The difference is that a segment is represented in terms of faces while a ROI is represented in terms of vertices. Therefore, the vertices that lie on the faces of each segment subject to deform are assigned to each ROI.

ROIs is then provided in the form of the data list of vertices C_{R}={V_{D}[r]:r=1, . . . , R_{D}}, where V_{D}[r]={v_{Dx}[r], v_{Dy}[r], v_{Dz}[r]}={v_{Dx}[r, i_{D}], v_{Dy}[r, i_{D}], v_{Dz}[r, i_{D}]:i_{D}=1, . . . , I_{D}[r]}, I_{D}[r] is the total number of vertices in the r-th ROI, and R_{D} is the total number of ROIs.

As shown in FIG. 13, the segment containing the left ear is subject to deform. The vertices lying on the faces that belong to this segment are then assigned to ROI.

### Mesh Editing

The mesh editing process considers only the sub-mesh of ROIs. In order to achieve a seamless transition with gradual change of detail between ROls and the rest, stationary anchors maybe needed. The positions of the vertices of manipulation handles and the stationary anchors constraint the reconstruction for the free vertices within ROIs. The Mesh Editing module involves three steps: (1) Obtain stationary anchors V_{A} according to [symbol] _{D}; (2) Obtain a set of manipulation handles H given [symbol] according to [symbol] _{D}; and (3) Obtain a deformed mesh [symbol] _{D} according to D.

### Obtain Stationary Anchors V_{A} According to _{D}

According to [symbol] _{D}, a transition region between the region to deform and the untouched region of the mesh may be required. The transition region may be obtained by enlarging the corresponding ROI to a certain degree, which is specified by users. The vertices in the transition regions become stationary anchors, denoted by V_{A}.

FIG. 14 shows an example where the transition region is constructed as the faces which lie outside the ROI, which is the left ear surface, within a sphere centered at left ear canal with a radius. The radius is calculated as 1.1 times the maximum Euclidian distance between the left ear canal and each point in the ROI.

### Obtain a Set of Manipulation Handles H Given According to

Recall that [symbol] _{D} describes handles' control parameters, which may contain, e.g.,

[symbol] _{D}⊆ [symbol] specifying physical features to deform;

ρ specifying the level of deformation of each feature in [symbol] _{D}, e.g., the level of a feature to be enlarged or shrunk.

Manipulation handles are the landmarks corresponding to the physical features specified in [symbol] _{D}. The original coordinates of the vertices of the manipulation handles are obtained from [symbol] , and denoted by V_{H}={v_{Hx}[l_{H}], v_{Hy}[l_{H}], v_{Hz}[l_{H}]:l_{H}=1, . . . , L_{H}} where L_{H} is the total number of the manipulation handles. Note that V_{H}⊂C_{R}. From V_{H} and ρ, the desired new coordinates of the control handles are computed and stored in U_{H}={u_{Hx}[l_{H}], u_{Hy}[l_{H}], u_{Hz}[l_{H}]:l_{H}=1, . . . , L_{H}}.

The complete set of control handles H consists of the original coordinates of the control handles and the desired new coordinates of the control handles, i.e., H={V_{H}, U_{H}}.

### Obtain a Deformed Mesh According to D

Embodiments herein may edit the mesh using any suitable algorithm. In some embodiments, the choice of algorithm is specified by the user in the mesh editing specification. In one embodiment, Laplacian Surface Editing (See Sorkine et al.) is applied, which operates the editing over an intrinsic surface representation based on Laplacian coordinates so that the geometric details of the ear surface are preserved.

The mesh editing process may be performed on the entire mesh [symbol] _{O}. This usually works sufficiently well in the case of a coarse deformation, e.g., enlarge the size of head. For a more delicate deformation, such as deforming a feature of an ear, it is more effective and more efficient to consider a sub-mesh of only the ROIs C_{R} during the editing process.

The new coordinates of the free vertices in C_{R}, denoted by

$${V}_{D}^{′} ,$$

are obtained by solving a linear least-square system with constraints imposed by the handle vertices U_{H} and the stationary anchors V_{A}. See Sorkine et al. for detailed explanation on this operation.

After then, the original vertices V_{O} is updated by replacing the ones within C_{R} with

$${V}_{D}^{′} ,$$

and the deformed mesh is obtained,

$${D}_{} = \{ {V}_{O}^{′} , {F}_{O} \} .$$

Even though embodiments herein have been exemplified with the deformation of 3D meshes of ear/head/torso of human subjects, embodiments herein are generally applicable for deforming of any class of 3D meshes.

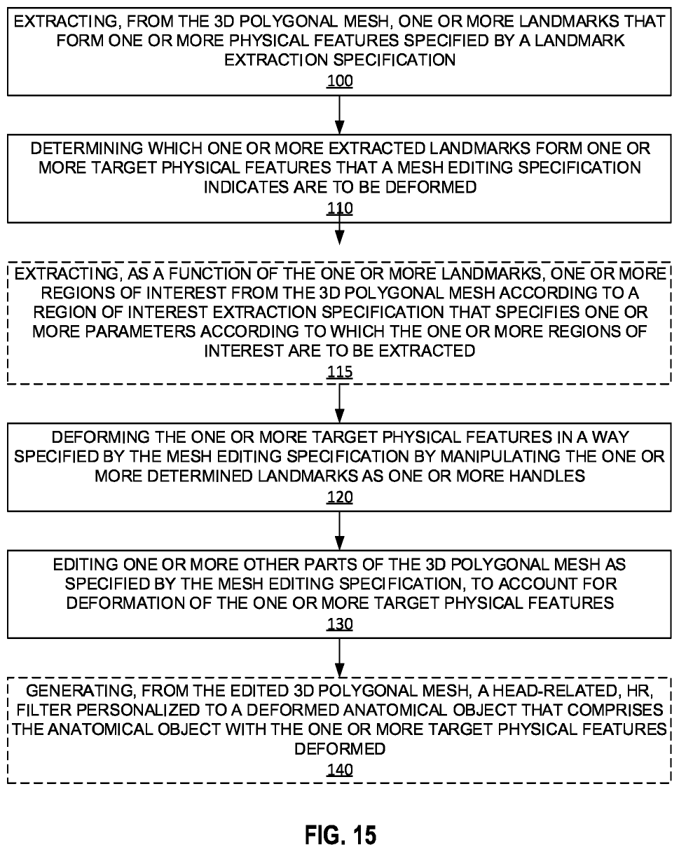

In view of the modifications and variations herein, FIG. 15 depicts a method in accordance with particular embodiments. The method is performed by computing equipment 10 for deforming a three-dimensional, 3D, polygonal mesh 12. The method includes extracting, from the 3D polygonal mesh 12, one or more landmarks 20 that form one or more physical features 22 specified by a landmark extraction specification 16 (Block 100). The method also includes determining which one or more extracted landmarks 20 form one or more target physical features 22T that a mesh editing specification 18 indicates are to be deformed (Block 110). The method further includes deforming the one or more target physical features 22T in a way specified by the mesh editing specification 18 by manipulating the one or more determined landmarks 20 as one or more handles (Block 120). The method also includes editing one or more other parts of the 3D polygonal mesh 12 as specified by the mesh editing specification 18, to account for deformation of the one or more target physical features 22T (Block 130).

In some embodiments, the method also includes extracting, as a function of the one or more landmarks 20, one or more regions of interest 19 from the 3D polygonal mesh 12 according to a region of interest extraction specification 21 that specifies one or more parameters 25 according to which the one or more regions of interest 19 are to be extracted (Block 115). In this case, editing the one or more other parts of the 3D polygonal mesh 12 may comprise editing the one or more other parts of the 3D polygonal mesh 12 based on the one or more regions of interest 19 extracted.

Alternatively or additionally, the method may further include generating, from the edited 3D polygonal mesh 12D, a head-related, HR, filter 50, e.g., personalized to a deformed anatomical object that comprises the anatomical object with the one or more target physical features 22T deformed (Block 140). In fact, in some embodiments, this may be performed as part of generating multiple HR transfer function filters 50-1, 50-2, . . . 50-N personalized to different anatomical objects, e.g., by deforming the same 3D polygonal mesh 12 according to multiple different mesh editing specifications 18-1, 18-2, . . . 18-N that specify different ways to deform the one or more target physical features 22T and/or different target physical features 22T to deform.

Embodiments herein also include corresponding apparatuses. Embodiments herein for example include computing equipment 10 configured to perform any of the steps of any of the embodiments described above for the computing equipment 10.

Embodiments also include computing equipment 10 comprising processing circuitry and power supply circuitry. The processing circuitry is configured to perform any of the steps of any of the embodiments described above for the computing equipment 10. The power supply circuitry is configured to supply power to the computing equipment 10.

Embodiments further include computing equipment 10 comprising processing circuitry. The processing circuitry is configured to perform any of the steps of any of the embodiments described above for the computing equipment 10. In some embodiments, the computing equipment 10 further comprises communication circuitry.

Embodiments further include computing equipment 10 comprising processing circuitry and memory. The memory contains instructions executable by the processing circuitry whereby the computing equipment 10 is configured to perform any of the steps of any of the embodiments described above for the computing equipment 10.

More particularly, the computing equipment 10 described above may perform the methods herein and any other processing by implementing any functional means, modules, units, or circuitry. Circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

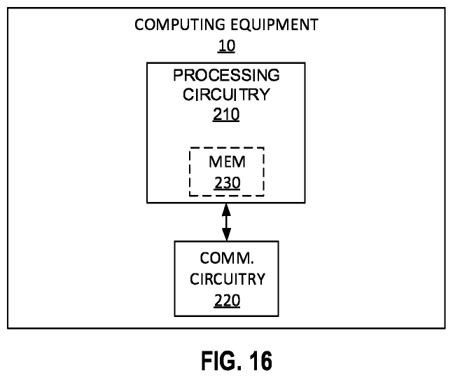

FIG. 16 for example illustrates computing equipment 10 as implemented in accordance with one or more embodiments. As shown, the computing equipment 10 includes processing circuitry 210. The processing circuitry 210 is configured to perform processing described above, e.g., in FIG. 15, such as by executing instructions stored in memory 230. The processing circuitry 210 in this regard may implement certain functional means, units, or modules.

In some embodiments, the computing equipment 10 further comprises communication circuitry 220 configured to transmit and/or receive information to and/or from one or more other nodes, e.g., via any communication technology. The computing equipment 10 may for example obtain the 3D polygonal mesh 12 via the communication circuitry 220.

Those skilled in the art will also appreciate that embodiments herein further include corresponding computer programs.

A computer program comprises instructions which, when executed on at least one processor of computing equipment 10, cause the computing equipment 10 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of computing equipment 10, cause the computing equipment 10 to perform as described above.

Embodiments further include a computer program product comprising program code portions for performing the steps of any of the embodiments herein when the computer program product is executed by computing equipment 10. This computer program product may be stored on a computer readable recording medium.

Example embodiments of the techniques and apparatus described herein include, but are not limited to, the following enumerated examples:
1. A method performed by computing equipment for deforming a three-dimensional, 3D, polygonal mesh, the method comprising:
   extracting, from the 3D polygonal mesh, one or more landmarks that form one or more physical features specified by a landmark extraction specification, wherein the landmark extraction specification specifies the one or more physical features by including one or more semantic labels of the one or more physical features, wherein the one or more semantic labels are associated with one or more parameters according to which the one or more landmarks are to be extracted;
   determining which one or more extracted landmarks form one or more target physical features that a mesh editing specification indicates are to be deformed;
   deforming the one or more target physical features in a way specified by the mesh editing specification by manipulating the one or more determined landmarks as one or more handles; and
   editing one or more other parts of the 3D polygonal mesh as specified by the mesh editing specification, to account for deformation of the one or more target physical features.
2. The method of embodiment 1, wherein the landmark extraction specification specifies the one or more parameters according to which the one or more landmarks are to be extracted.
3. The method of any of embodiments 1-2, wherein the one or more parameters according to which the one or more landmarks are to be extracted include, for each of the one or more physical features, one or more of:
   a view of the 3D polygonal mesh from which a two-dimensional, 2D, outline of the 3D polygonal mesh is to be extracted;
   a resolution of points that are to form the 2D outline; or
   a range of points on the 2D outline within which to search for one or more landmarks that form the physical feature.
4. The method of any of embodiments 1-3, wherein extracting the one or more landmarks comprises:
   for each of one or more views specified by the landmark extraction specification, extracting a 2D outline of the 3D polygonal mesh from a perspective of the view and at a resolution specified by the landmark extraction specification; and
   searching for the one or more landmarks within one or more ranges of points on the 2D outline specified by the landmark extraction specification.
5. The method of any of embodiments 1-4, wherein the mesh editing specification indicates the one or more target physical features by indicating one or more semantic labels of the one or more target physical features.
6. The method of any of embodiments 1-5, wherein the mesh editing specification specifies the way that the one or more target physical features are to be deformed by specifying, for each target physical feature, one or more of:
   an amount, ratio, or coefficient by which the target physical feature is to be moved or scaled; or
   an angle by which the target physical feature is to rotated.
7. The method of any of embodiments 1-6, wherein manipulating the one or more handles comprises re-locating the one or more handles in the 3D polygonal mesh as needed to move, scale, and/or rotate the one or more target physical features to an extent specified by the mesh editing specification, and wherein editing the one or more other parts of the 3D polygonal mesh comprises editing the one or more other parts of the 3D polygonal mesh according to an algorithm specified by the mesh editing specification, constrained by the one or more handles as re-located.
8. The method of any of embodiments 1-7, further comprising extracting, as a function of the one or more landmarks, one or more regions of interest from the 3D polygonal mesh according to a region of interest extraction specification that specifies one or more parameters according to which the one or more regions of interest are to be extracted, wherein each of the one or more regions of interest is a region within which the one or more target physical features are to be deformed, and wherein editing the one or more other parts of the 3D polygonal mesh comprises editing the one or more other parts of the 3D polygonal mesh based on the one or more regions of interest extracted.
9. The method of embodiment 8, wherein extracting the one or more regions of interest comprise:
   extracting a sub-mesh from the 3D polygonal mesh, or a simplified version thereof, according to the region of interest extraction specification, as a function of the one or more extracted landmarks; and
   obtaining the one or more regions of interest from the extracted sub-mesh.
10. The method of embodiment 9, wherein the region of interest extraction specification specifies a distance threshold, wherein extracting the sub-mesh comprises extracting the sub-mesh as one or more portions of the 3D polygonal mesh that are located within the distance threshold of one or more extracted landmarks.
11. The method of any of embodiments 1-10, wherein the 3D polygonal mesh is a 3D polygonal mesh of an anatomical object, wherein the one or more physical features are one or more anatomical features, and wherein the one or more target physical features are one or more target anatomical features.
12. The method of embodiment 11, wherein the anatomical object includes a head, one or more ears, and/or an upper torso.
13. The method of any of embodiments 11-12, further comprising generating, from the edited 3D polygonal mesh, a head-related, HR, filter personalized to a deformed anatomical object that comprises the anatomical object with the one or more target physical features deformed.
14. The method of embodiment 13, further comprising generating multiple HR filters personalized to different anatomical objects, by deforming the same 3D polygonal mesh according to multiple different mesh editing specifications that specify different ways to deform the one or more target physical features and/or different target physical features to deform.
15. Computing equipment configured to:
   extract, from the 3D polygonal mesh, one or more landmarks that form one or more physical features specified by a landmark extraction specification, wherein the landmark extraction specification specifies the one or more physical features by including one or more semantic labels of the one or more physical features, wherein the one or more semantic labels are associated with one or more parameters according to which the one or more landmarks are to be extracted;
   determine which one or more extracted landmarks form one or more target physical features that a mesh editing specification indicates are to be deformed;
   deform the one or more target physical features in a way specified by the mesh editing specification by manipulating the one or more determined landmarks as one or more handles; and
   edit one or more other parts of the 3D polygonal mesh as specified by the mesh editing specification, to account for deformation of the one or more target physical features.
16. The computing equipment of embodiment 15, configured to perform the method of any of embodiments 2-14.
17.A computer program comprising instructions which, when executed by at least one processor of computing equipment, causes the computing equipment to perform the method of any of embodiments 1-14.
18. A carrier containing the computer program of embodiment 17, wherein the carrier is one of an electronic signal, optical signal, radio signal, or computer readable storage medium.
19. Computing equipment comprising processing circuitry configured to:
   extract, from the 3D polygonal mesh, one or more landmarks that form one or more physical features specified by a landmark extraction specification, wherein the landmark extraction specification specifies the one or more physical features by including one or more semantic labels of the one or more physical features, wherein the one or more semantic labels are associated with one or more parameters according to which the one or more landmarks are to be extracted;
   determine which one or more extracted landmarks form one or more target physical features that a mesh editing specification indicates are to be deformed;
   deform the one or more target physical features in a way specified by the mesh editing specification by manipulating the one or more determined landmarks as one or more handles; and
   edit one or more other parts of the 3D polygonal mesh as specified by the mesh editing specification, to account for deformation of the one or more target physical features.
20. The computing equipment of embodiment 19, the processing circuitry configured to perform the method of any of embodiments 2-14.

### REFERENCES

[1] V. R. Algazi, R. O. Duda, D. M. Thompson and C. Avendano, “The CIPIC HRTF Database,” in IEEE Workshop on Applications of Signal Processing to Audio and Electroacoustics, Mohonk Mountain House, New Paltz, NY, 2001.
[2] W. Kreuzer, P. Majdak and Z. Chen, “Fast multipole boundary element method to calculate head-related transfer functions for a wide frequency range,” The Journal of the Acoustical Society of America, vol. 126, no. 3, pp. 1280-1290, 2009.
[3] H. Ziegelwanger, A. Reichinger and P. Majdak, “Calculation of listener-specific head-related transfer functions: Effect of mesh quality,” in Proceedings of Meetings on Acoustics, Montreal, Canada, 2013.
[4] J. R. Nieto and A. Susin, “Cage based deformations: a survey,” in Deformation models, Springer, 2013, pp. 75-99.
[5] O. Sorkine, D. Cohen-Or, Y. Lipman, M. Alexa, C. Rössl and H.-P. Seidel, “Laplacian surface editing,” in Eurographics Symposium on Geometry Processing, Nice, France, 2004.
[6] M. Dinakaran, P. Grosche, F. Brinkmann and S. Weinzierl, “Extraction of anthropometric measures from 3D-meshes for the individualization of head-related transfer functions,” in AES 140th Convention, Paris, France, June 2016.
[7] M. Garland and P. S. Heckbert, “Surface simplification using quadric error metrics,” in The 24th annual conference on Computer graphics and interactive techniques, Los Angeles, US, 1997.
[8] R. Liu and H. Zhang, “Segmentation of 3D Meshes through Spectral Clustering,” in The 12th Pacific Conference on Computer Graphics and Applications, Seoul, South Korea, 2004.

1.-33. (canceled)

34. A method performed by computing equipment for deforming a three-dimensional (3D) polygonal mesh, the method comprising:
extracting, from the 3D polygonal mesh, one or more landmarks that form one or more physical features specified by a landmark extraction specification, wherein the landmark extraction specification specifies the one or more physical features by including one or more semantic labels of the one or more physical features, wherein the one or more semantic labels are associated with one or more parameters according to which the one or more landmarks are to be extracted;
determining which one or more extracted landmarks form one or more target physical features that a mesh editing specification indicates are to be deformed;
deforming the one or more target physical features in a way specified by the mesh editing specification by manipulating the one or more determined landmarks as one or more handles; and
editing one or more other parts of the 3D polygonal mesh as specified by the mesh editing specification, to account for deformation of the one or more target physical features.

35. The method according to claim 34, wherein the landmark extraction specification specifies the one or more parameters according to which the one or more landmarks are to be extracted.

36. The method according to claim 34, wherein the one or more parameters according to which the one or more landmarks are to be extracted include, for each of the one or more physical features, one or more of:
a view of the 3D polygonal mesh from which a two-dimensional (2D) outline of the 3D polygonal mesh is to be extracted;
a resolution of points that are to form the 2D outline; or
a range of points on the 2D outline within which to search for one or more landmarks that form the physical feature.

37. The method according to claim 34, wherein extracting the one or more landmarks comprises:
for each of one or more views specified by the landmark extraction specification, extracting a 2D outline of the 3D polygonal mesh from a perspective of the view and at a resolution specified by the landmark extraction specification; and
searching for the one or more landmarks within one or more ranges of points on the 2D outline specified by the landmark extraction specification.

38. The method according to claim 34, wherein the mesh editing specification indicates the one or more target physical features by indicating one or more semantic labels of the one or more target physical features.

39. The method according to claim 34, wherein the mesh editing specification specifies the way that the one or more target physical features are to be deformed by specifying, for each target physical feature, one or more of:
an amount, ratio, or coefficient by which the target physical feature is to be moved or scaled; or
an angle by which the target physical feature is to be rotated.

40. The method according to claim 34, wherein manipulating the one or more handles comprises re-locating the one or more handles in the 3D polygonal mesh as needed to move, scale, and/or rotate the one or more target physical features to an extent specified by the mesh editing specification, and wherein editing the one or more other parts of the 3D polygonal mesh comprises editing the one or more other parts of the 3D polygonal mesh according to an algorithm specified by the mesh editing specification, constrained by the one or more handles as re-located.

41. The method according to claim 34, further comprising extracting, as a function of the one or more landmarks, one or more regions of interest from the 3D polygonal mesh according to a region of interest extraction specification that specifies one or more parameters according to which the one or more regions of interest are to be extracted, wherein each of the one or more regions of interest is a region within which the one or more target physical features are to be deformed, and wherein editing the one or more other parts of the 3D polygonal mesh comprises editing the one or more other parts of the 3D polygonal mesh based on the one or more regions of interest extracted.

42. The method according to claim 34, wherein the 3D polygonal mesh is a 3D polygonal mesh of an anatomical object, wherein the one or more physical features are one or more anatomical features, and wherein the one or more target physical features are one or more target anatomical features.

43. The method according to claim 42, wherein the anatomical object includes a head, one or more ears, and/or an upper torso.

44. The method according to claim 34, further comprising generating, from the edited 3D polygonal mesh, a head-related, HR, filter personalized to a deformed anatomical object that comprises the anatomical object with the one or more target physical features deformed.

45. The method according to claim 44, further comprising generating multiple HR filters personalized to different anatomical objects, by deforming the same 3D polygonal mesh according to multiple different mesh editing specifications that specify different ways to deform the one or more target physical features and/or different target physical features to deform.

46. A computing equipment comprising processing circuitry configured to:
extract, from a three-dimensional (3D) polygonal mesh, one or more landmarks that form one or more physical features specified by a landmark extraction specification, wherein the landmark extraction specification specifies the one or more physical features by including one or more semantic labels of the one or more physical features, wherein the one or more semantic labels are associated with one or more parameters according to which the one or more landmarks are to be extracted;
determine which one or more extracted landmarks form one or more target physical features that a mesh editing specification indicates are to be deformed;
deform the one or more target physical features in a way specified by the mesh editing specification by manipulating the one or more determined landmarks as one or more handles; and
edit one or more other parts of the 3D polygonal mesh as specified by the mesh editing specification, to account for deformation of the one or more target physical features.

47. The computing equipment according to claim 46, wherein the landmark extraction specification specifies the one or more parameters according to which the one or more landmarks are to be extracted.

48. The computing equipment according to claim 46, wherein the one or more parameters according to which the one or more landmarks are to be extracted include, for each of the one or more physical features, one or more of:
a view of the 3D polygonal mesh from which a two-dimensional (2D) outline of the 3D polygonal mesh is to be extracted;
a resolution of points that are to form the 2D outline; or
a range of points on the 2D outline within which to search for one or more landmarks that form the physical feature.

49. The computing equipment according to claim 46, wherein the processing circuitry is configured to extract the one or more landmarks by:
for each of one or more views specified by the landmark extraction specification, extracting a 2D outline of the 3D polygonal mesh from a perspective of the view and at a resolution specified by the landmark extraction specification; and
searching for the one or more landmarks within one or more ranges of points on the 2D outline specified by the landmark extraction specification.

50. The computing equipment according to claim 46, wherein the mesh editing specification indicates the one or more target physical features by indicating one or more semantic labels of the one or more target physical features.

51. The computing equipment according to claim 46, wherein the mesh editing specification specifies the way that the one or more target physical features are to be deformed by specifying, for each target physical feature, one or more of:
an amount, ratio, or coefficient by which the target physical feature is to be moved or scaled; or
an angle by which the target physical feature is to be rotated.

52. The computing equipment according to claim 46, wherein the processing circuitry is configured to manipulate the one or more handles by re-locating the one or more handles in the 3D polygonal mesh as needed to move, scale, and/or rotate the one or more target physical features to an extent specified by the mesh editing specification, and wherein the processing circuitry is configured to edit the one or more other parts of the 3D polygonal mesh by editing the one or more other parts of the 3D polygonal mesh according to an algorithm specified by the mesh editing specification, constrained by the one or more handles as re-located.

53. The computing equipment according to claim 46, wherein the processing circuitry is further configured to extract, as a function of the one or more landmarks, one or more regions of interest from the 3D polygonal mesh according to a region of interest extraction specification that specifies one or more parameters according to which the one or more regions of interest are to be extracted, wherein each of the one or more regions of interest is a region within which the one or more target physical features are to be deformed, and wherein the processing circuitry is configured to edit the one or more other parts of the 3D polygonal mesh by editing the one or more other parts of the 3D polygonal mesh based on the one or more regions of interest extracted.
